(19) United States
(12) Patent Application Publication
(10) Pub. No.: US 2013/0096946 A1
(43) Pub. Date: Apr. 18, 2013

(54) Method and System for Ontology Based Analytics

(71) Applicants: Nigam Shah, San Jose, CA (US); Paea LePendu, Menlo Park, CA (US); Srinivasan Iyer, Stanford, CA (US); Yi Liu, Stanford, CA (US)

(72) Inventors: Nigam Shah, San Jose, CA (US); Paea LePendu, Menlo Park, CA (US); Srinivasan Iyer, Stanford, CA (US); Yi Liu, Stanford, CA (US)

(73) Assignee: The Board of Trustees of the Leland Stanford, Junior, University, Palo Alto, CA (US)

(21) Appl. No.: 13/424,375

(22) Filed: Mar. 19, 2012

Related U.S. Application Data
(63) Continuation-in-part of application No. 13/273,038, filed on Oct. 13, 2011.

(51) Int. Cl. G06Q 50/24

(52) U.S. Cl. 705/3

(57) ABSTRACT

The present invention provides a mechanism to use terminologies and ontologies for the purpose of indexing, annotating and semantically marking up existing collections of datasets. The invention further provides a system for incorporating terminologies, ontologies, and contextual annotation in specific domains, such as utilizing biomedical concept hierarchies in data analytics. The resulting rich structure supports specific mechanisms for data mining and machine learning.

### FIELD OF THE INVENTION

The present invention generally relates to the field of digital medical records. More particularly, the present invention relates to a method and system for analyzing the contents of digital medical records.

### BACKGROUND OF THE INVENTION

The range of publicly available biomedical data is enormous and is expanding quickly. This expansion means that researchers now face a hurdle to extracting the data they need from the large numbers of data that are available. Biomedical researchers have turned to ontologies and terminologies to structure and annotate their data with ontology concepts for better search and retrieval. However, this annotation process cannot be easily automated and often requires expert curators. Plus, there is a lack of easy-to-use systems that facilitate the use of ontologies for annotation.

The annotation of biomedical data with biomedical ontology concepts is not a common practice for several reasons:
Annotation often needs to be done manually either by expert curators or directly by the authors of the data (e.g., when a new Medline entry is created, it is manually indexed with MeSH terms);
The number of biomedical ontologies available for use is large and ontologies change often and frequently overlap. The ontologies are not in the same format and are not always accessible via application programming interfaces (APIs) that allow users to query them programmatically;
Users do not always know the structure of an ontology's content or how to use the ontology to do the annotation themselves;
Annotation is often a boring additional task without immediate reward for the user.

One area in which there is much data but where such data is difficult to analyze is in the area of adverse drug interactions. Clinical trials, which test the safety and efficacy of drugs in a controlled population, cannot identify all safety issues associated with drugs because the size and characteristics of the target population, duration of use, the concomitant disease conditions, and therapies differ markedly from actual usage conditions. In the ambulatory care setting, medication related adverse events in the United States are estimated to result in 100,000 deaths and to cost $177 billion annually. On the inpatient side, it is estimated that roughly 30% of hospital stays have an adverse drug event. Currently, no one monitors the “real life” situation of patients getting over 3 concomitant drugs.

The current paradigm of drug safety surveillance is based on spontaneous reporting systems (SRS), containing voluntarily submitted reports of suspected adverse drug events encountered during clinical practice. In the United States, the primary database for such reports is the AERS database at the FDA. The reports in these databases are typically mined for drug-event associations via statistical methods based on disproportionality measures, which quantify the magnitude of difference between observed and expected rates of particular drug-event pairs. The FDA screens the AERS database for the presence of an unexpectedly high number of reports of a given adverse event for a drug product using the empirical Bayes multi-item gamma Poisson shrinker (MGPS) data mining protocol, which includes numerous stratification steps to minimize false positive signals.

Given the amount of data available in AERS, it is desirable to develop methods for detecting potential new multi-drug adverse events for detecting multi-item adverse events, and for discovering drug groups that share a common set of AEs. Also, it is desirable to use other data sources, such as EHRs, for the purpose of detecting potential new AEs in order to counterbalance the biases inherent in AERS and to discover multi-drug AEs. Moreover, it is desirable to use billing and claims data for active drug safety surveillance, applied literature mining for drug safety, and reasoning over published literature to discover drug-drug interactions based on properties of drug metabolism.

Off-label usage of drugs—the prescription of a medication differently than approved by the FDA—is done often in the absence of adequate scientific evidence. Off-label usage is becoming very common and in most cases, the safety profile of a drug when used off-label is not known. Off-label uses that result in frequent AEs become a major safety and cost issue. Research on detection of adverse drug events and off-label usage is generally carried out separately. But given the interplay between the costs associated with drug-related AEs and the high rate of unintended “blind” interactions resulting from the use of multiple drugs, it is crucial to study these problems jointly.

Given the amount of self-reported data, the increasing searches for health information online, and the increasing access to electronic health records, there is a need in the art to combine multiple data sources for active surveillance of drug safety profiles. There is a further need in the art to use existing public ontologies for drugs and diseases, unstructured textual sources after automated processing, and complementary data sources for new methods that can overcome the limitations of the prior art to construct a data-driven safety profile for drugs.

There is, therefore, a need for a methods and systems for analyzing digital medical records in view of ontologies as well as graph structures. There is further a need in particular areas, including, for example, the study of adverse drug interactions for a method and system for analyzing large volumes of data toward providing predictive results.

### SUMMARY OF THE INVENTION

Given the interplay between the costs associated with drug-related adverse events and the high rate of “blind” interactions resulting from the use of multiple drugs in the presence of multiple co-morbidities, it is crucial to address these problems jointly. Moreover, given the amount of data in spontaneous reporting systems (such as the Adverse Events Report System, AERS), the increase in exchange of electronic health records (EHR), the availability of tools for automated coding of unstructured text using natural language processing, the existence of over 250 biomedical ontologies, and the increasing access to large volumes of electronic medical data, an embodiment of the present invention jointly addresses the drug-safety surveillance and the safety of off-label usage. Other embodiments of the present invention, however, can be applied in other areas where drug and disease interaction play a role.

An embodiment of the invention includes an annotation workflow that uses approximately 250 public biomedical ontologies for the purpose of performing large-scale annotations on the unstructured data available in medicine and health care. Applications of the present invention allow for the discovery of previously unreported adverse events of multi-drug combinations. The present invention also allows for the discovery of profiles of drugs used off-label. Also, the present invention can be used to validate the adverse event profiles of drug combinations and the safety profiles of drugs used off-label. More broadly, the teachings of the present invention allow for analyzing large amounts of unstructured data to develop relationships and models for two or more factors, e.g., drug and disease interaction, symptom and disease interaction, etc.

The present invention provides advantages over the prior art because the prior art is not able to fully use aggregations provided by existing public ontologies for drugs, diseases, and adverse events. Also, prior art methods are not able to identify multi-drug adverse events not to combine EHR data with AERS data to compensate for each other's biases as embodiments of the present invention are able to do.

Other embodiments of the present invention provide data-driven insights into the safety profiles of drugs used off-label. The present invention allows for systematic reviews of off-label drug use to focus on drugs that are used frequently and have a high rate of adverse events. An embodiment of the invention combines datasets that capture complimentary dimensions about drug adverse events: the EHR, which is the observed data, the AERS which is the reported data, health search logs, which are a proxy for what patients worry about, and physicians' query logs, which show what doctors are concerned about. In an embodiment, triangulation is used with these data sources to identify adverse events in an efficient and accurate manner.

An embodiment of the invention uses hierarchies provided by existing public ontologies for drugs, diseases, and adverse events to improve signal detection by aggregation, to reduce multiple hypothesis testing, and to make a searches for multi-drug induced adverse events computationally tractable. In another embodiment, data is used from health search logs, electronic medical records, adverse event reports in AERS, and prior knowledge in curated knowledge bases to construct a data-driven safety profile for drugs. In yet another embodiment, hierarchies can be applied more broadly to investigate the interaction of one hierarchy (e.g., drug) with another hierarchy (e.g., disease, adverse event, etc.).

Other embodiments of the present invention provide a mechanism to use terminologies and ontologies for the purpose of indexing, annotating and semantically marking up existing collections of datasets. The invention further provides a system for incorporating terminologies, ontologies, and contextual annotation in specific domains, such as utilizing biomedical concept hierarchies in data analytics. The resulting rich structure supports specific mechanisms for data mining and machine learning.

Moreover, the present invention provides a system for structuring and analyzing a data set, including use of natural language processing, ontologic annotation, other contextual annotation such as temporal references, and machine learning for data mining.

These and other embodiments can be more fully appreciated upon an understanding of the detailed description of the invention as disclosed below in conjunction with the attached figures.

### BRIEF DESCRIPTION OF THE DRAWINGS

The following drawings will be used to more fully describe embodiments of the present invention.

FIG. 1 illustrates an exemplary networked environment and its relevant components according to aspects of the present invention.

FIG. 2 is an exemplary block diagram of a computing device that may be used to implement aspects of certain embodiments of the present invention.

FIG. 3 is depicts graph structures according to an embodiment of the present invention.

FIG. 4 depicts a block diagram of an implementation of the present invention.

FIG. 5 depicts a flow chart relating to a method for performing analyses of digital medical records according to an embodiment of the present invention.

FIG. 6 includes a block diagram of certain aspects of an embodiment of the present invention.

FIG. 7 is a visualization of analysis results obtained according to an embodiment of the present invention.

FIG. 8 illustrates the formation of a contingency table according to an embodiment of the present invention.

FIG. 9 illustrates the formation of patient timelines according to an embodiment of the present invention.

FIG. 10 depicts a flow chart relating to a method for performing analyses of digital medical records according to an embodiment of the present invention.

FIG. 11 illustrates an LOESS regression according to an embodiment of the present invention.

FIG. 12 is a graph that illustrates the performance of an embodiment of the present invention.

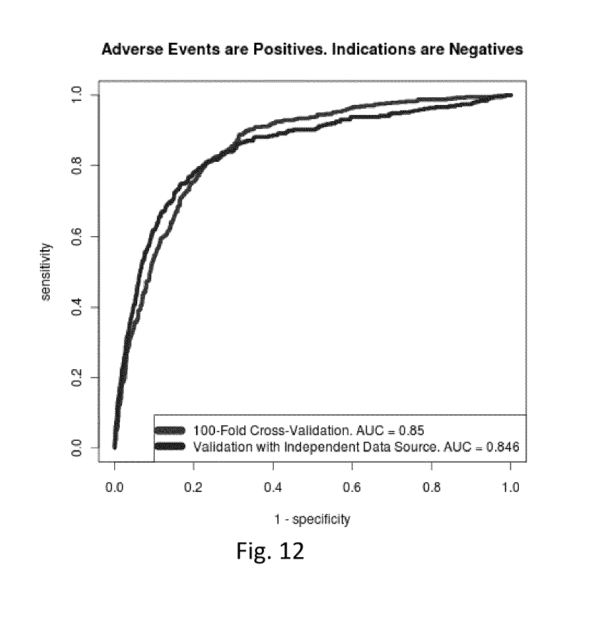

### DETAILED DESCRIPTION OF THE INVENTION

Those of ordinary skill in the art will realize that the following description of the present invention is illustrative only and not in any way limiting. Other embodiments of the invention will readily suggest themselves to such skilled persons, having the benefit of this disclosure. Reference will now be made in detail to specific implementations of the present invention as illustrated in the accompanying drawings. The same reference numbers will be used throughout the drawings and the following description to refer to the same or like parts.

Further, certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory that can direct a computer or other programmable apparatus to function in a particular manner, such that the instructions stored in the computer-readable memory produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C# (CSharp), Perl, Ada, Python, Pascal, SmallTalk, FORTRAN, assembly language, and the like, may be used to implement aspects of the present invention. Further, various programming approaches such as procedural, object-oriented or artificial intelligence techniques may be employed, depending on the requirements of each particular implementation. Compiler programs and/or virtual machine programs executed by computer systems generally translate higher level programming languages to generate sets of machine instructions that may be executed by one or more processors to perform a programmed function or set of functions.

The term “machine-readable medium” should be understood to include any structure that participates in providing data which may be read by an element of a computer system. Such a medium may take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, any other magnetic medium, a CD-ROM, a DVD, any other optical medium.

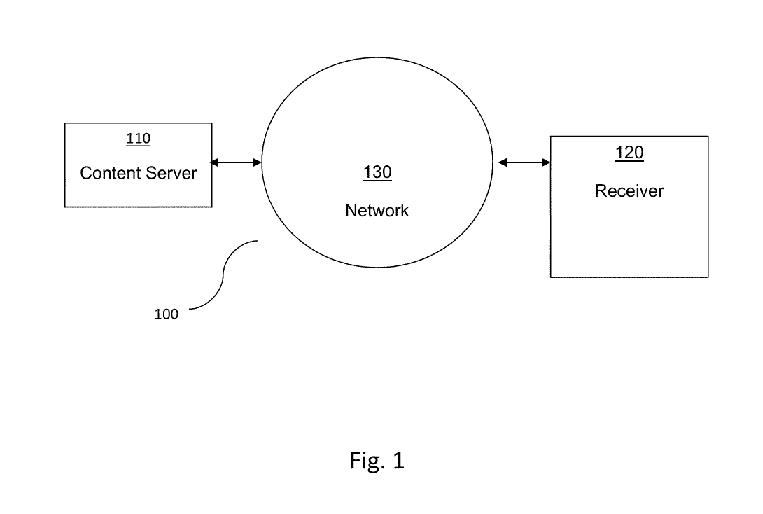

FIG. 1 depicts an exemplary networked environment 100 in which systems and methods, consistent with exemplary embodiments, may be implemented. As illustrated, networked environment 100 may include a content server 110, a receiver 120, and a network 130. The exemplary simplified number of content servers 110, receivers 120, and networks 130 illustrated in FIG. 1 can be modified as appropriate in a particular implementation. In practice, there may be additional content servers 110, receivers 120, and/or networks 130.

In certain embodiments, a receiver 120 may include any suitable form of multimedia playback device, including, without limitation, a computer, a gaming system, a cable or satellite television set-top box, a DVD player, a digital video recorder (DVR), or a digital audio/video stream receiver, decoder, and player. A receiver 120 may connect to network 130 via wired and/or wireless connections, and thereby communicate or become coupled with content server 110, either directly or indirectly. Alternatively, receiver 120 may be associated with content server 110 through any suitable tangible computer-readable media or data storage device (such as a disk drive, CD-ROM, DVD, or the like), data stream, file, or communication channel.

Network 130 may include one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, and/or another type of suitable network, depending on the requirements of each particular implementation.

One or more components of networked environment 100 may perform one or more of the tasks described as being performed by one or more other components of networked environment 100.

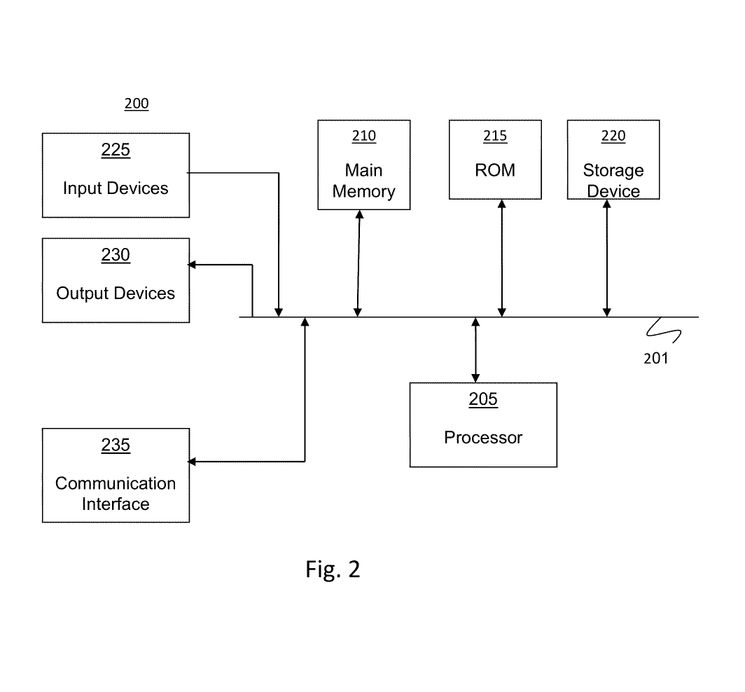

FIG. 2 is an exemplary diagram of a computing device 200 that may be used to implement aspects of certain embodiments of the present invention, such as aspects of content server 110 or of receiver 120. Computing device 200 may include a bus 201, one or more processors 205, a main memory 210, a read-only memory (ROM) 215, a storage device 220, one or more input devices 225, one or more output devices 230, and a communication interface 235. Bus 201 may include one or more conductors that permit communication among the components of computing device 200.

Processor 205 may include any type of conventional processor, microprocessor, or processing logic that interprets and executes instructions. Moreover, processor 205 may include processors with multiple cores. Also, processor 205 may be multiple processors. Main memory 210 may include a random-access memory (RAM) or another type of dynamic storage device that stores information and instructions for execution by processor 205. ROM 215 may include a conventional ROM device or another type of static storage device that stores static information and instructions for use by processor 205. Storage device 220 may include a magnetic and/or optical recording medium and its corresponding drive.

Input device(s) 225 may include one or more conventional mechanisms that permit a user to input information to computing device 200, such as a keyboard, a mouse, a pen, a stylus, handwriting recognition, voice recognition, biometric mechanisms, and the like. Output device(s) 230 may include one or more conventional mechanisms that output information to the user, including a display, a projector, an A/V receiver, a printer, a speaker, and the like. Communication interface 235 may include any transceiver-like mechanism that enables computing device/server 200 to communicate with other devices and/or systems. For example, communication interface 235 may include mechanisms for communicating with another device or system via a network, such as network 130 as shown in FIG. 1.

As will be described in detail below, computing device 200 may perform operations based on software instructions that may be read into memory 210 from another computer-readable medium, such as data storage device 220, or from another device via communication interface 235. The software instructions contained in memory 210 cause processor 205 to perform processes that will be described later. Alternatively, hardwired circuitry may be used in place of or in combination with software instructions to implement processes consistent with the present invention. Thus, various implementations are not limited to any specific combination of hardware circuitry and software.

A web browser comprising a web browser user interface may be used to display information (such as textual and graphical information) on the computing device 200. The web browser may comprise any type of visual display capable of displaying information received via the network 130 shown in FIG. 1, such as Microsoft's Internet Explorer browser, Netscape's Navigator browser, Mozilla's Firefox browser, PalmSource's Web Browser, Google's Chrome browser or any other commercially available or customized browsing or other application software capable of communicating with network 130. The computing device 200 may also include a browser assistant. The browser assistant may include a plug-in, an applet, a dynamic link library (DLL), or a similar executable object or process. Further, the browser assistant may be a toolbar, software button, or menu that provides an extension to the web browser. Alternatively, the browser assistant may be a part of the web browser, in which case the browser would implement the functionality of the browser assistant.

The browser and/or the browser assistant may act as an intermediary between the user and the computing device 200 and/or the network 130. For example, source data or other information received from devices connected to the network 130 may be output via the browser. Also, both the browser and the browser assistant are capable of performing operations on the received source information prior to outputting the source information. Further, the browser and/or the browser assistant may receive user input and transmit the inputted data to devices connected to network 130.

Similarly, certain embodiments of the present invention described herein are discussed in the context of the global data communication network commonly referred to as the Internet. Those skilled in the art will realize that embodiments of the present invention may use any other suitable data communication network, including without limitation direct point-to-point data communication systems, dial-up networks, personal or corporate Intranets, proprietary networks, or combinations of any of these with or without connections to the Internet.

The present disclosure provides a detailed explanation of the present invention with detailed explanations that allow one of ordinary skill in the art to implement the present invention into a computerized method. Certain of these and other details are not included in the present disclosure so as not to detract from the teachings presented herein but it is understood that one of ordinary skill in the at would be familiar with such details.

The present invention provides a mechanism to use terminologies and ontologies for the purpose of indexing, annotating and semantically marking up existing collections of datasets. The invention further provides a system for incorporating terminologies, ontologies, and contextual annotation in specific domains, such as utilizing biomedical concept hierarchies in data analytics. The resulting rich structure supports specific mechanisms for data mining and machine learning.

Moreover, the present invention provides a system for structuring and analyzing a data set, including use of natural language processing, ontologic annotation, other contextual annotation such as temporal references, and machine learning for data mining. Formulas for enrichment analysis and standard algorithms for machine learning are used in the present invention.

The present invention provides ready access to multiple hierarchies of biomedical concepts, that may only be available in incompatible formats, for the purpose of analytics. The present invention provides the ability to use any of the used hierarchies in downstream workflows (for example, for annotations, mapping and indexing) and the ability to replace one hierarchy for another, without changing the downstream workflow.

Included in the present invention is a set of application programming interfaces (APIs) as well as Web services that allow other software programs to use public ontologies for the above described purpose. The system includes implementations of the common types of uses of the APIs, such as for computationally annotating collections of unstructured textual data and for creating a corpus of annotations from public databases. The present invention includes applicability into data analysis and annotation analytics workflows.

The underlying technology stack, especially the storage back end can be changed to enhance speed and scalability. The API implementation protocol can be changed with changing Web standards and is not limited to the present disclosure.

The system of the present invention can be used for data analysis operations such as mining research papers and funded grants on a specific topic or mining medical records which contain a unique combination of concepts that are predictive of a desired (or undesired or unforeseen outcome).

In proceeding with the present disclosure, certain particular embodiments will be described to facilitate the disclosure of the present invention. One of ordinary skill in the art will understand that the present invention is not limited to such particular embodiments. Indeed, one of ordinary skill in the art appreciates the many different applications and embodiments for the present invention.

Medical research has collected and continues to collect much information. With such large collections of information, there have been various attempts to manage and understand such information. For example, the National Center for Biomedical Ontology maintains BioPortal, a repository that provides access to over 250 ontologies via Web services and Web browsers and offers “one-stop shopping” for biomedical ontologies. BioPortal provides the ability to programmatically access ontologies in annotation workflows as well provides mappings between terms across ontologies.

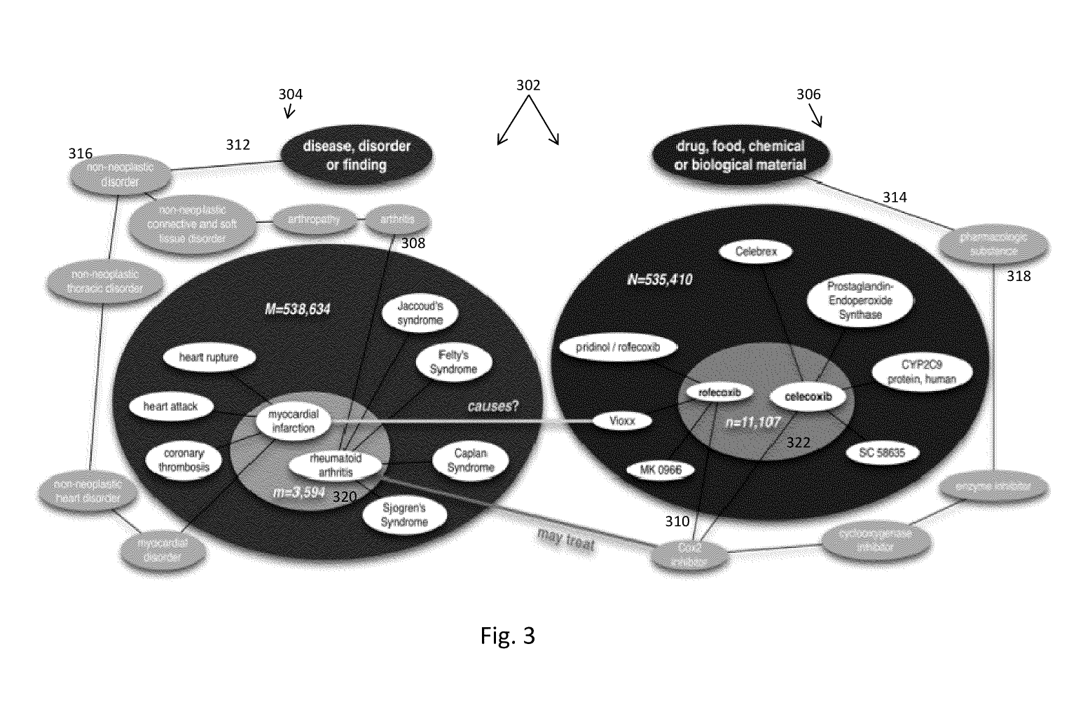

The mapped terms from different ontologies are combined into a single mega-thesaurus. Each mega-thesaurus entry groups together all similar classes and contains all the terms that are used for preferred names and synonyms for those classes. In addition, BioPortal incorporates many of the Unified Medical Language System (UMLS) terminologies to provide non-hierarchical relationships, such as may_treat and procedure_device_of, between terms of different types such as drugs and diseases. The parent-child relationships from over 250 ontologies, the synonymy mappings across multiple ontologies, and the non-hierarchical relationships form a rich knowledge graph (see FIG. 3) that are used in an annotation and analysis pipeline according to embodiments of the present invention.

In an embodiment used to analyze the effects of Vioxx, a knowledge graph as shown in FIG. 3 is developed. The knowledge graph 302 formed by the relationships in drug and disease ontologies, 304 and 306, respectively, and the mappings (e.g., 308 and 310) between terms belonging to different ontologies. The figure shows a subsection of a disease hierarchy 312 and a drug hierarchy 314 from the mega-thesaurus at BioPortal. Each node (e.g., 316 and 318) represents a class. The numbers (M=538,638 and N=535,410) show the total number of different terms from the mega-thesarus. The numbers (m=2,966 and n=11,107) in the inner circles 320 and 322, respectively, show the count of classes that remain after collapsing along various relationships (e.g., synonymy, ingredient_of, has_tradename, is_a) across all ontologies. The normalization resulting from collapsing the terms in clinical notes to such a knowledge graph results in a significant reduction in computation complexity.

As shown the knowledge graph includes public ontologies in BioPortal to bind diverse datasets, to improve signal detection, to reduce multiple hypothesis testing, and to make a search for multi-drug adverse events computationally tractable according to an embodiment of the invention. The hierarchical groupings provided by ontologies for drugs, diseases, and adverse events addresses multiple hypothesis testing and computational tractability because the number of drug-disease combinations decreases in the higher levels of aggregation in the ontology hierarchy.

As would be obvious to one of ordinary skill in the art, the structure of the knowledge graph can be applied in different scenarios. For example, a knowledge graph and be developed with appropriate hierarchies and connections to analyze adverse drug events associated with off-label usage of drugs.

Ontologies provide domain specific lexicons for use in natural language processing, indexing and information retrieval. The Lexicon Builder Web service provides ontology-based generation of lexicons from BioPortal. The service uses the hierarchical information present in ontologies as well as the term frequency and syntactic type information on individual terms mined from Medline to create “clean lexicons.”

Because most biomedical concepts are noun phrases, the quality of disease lexicons derived from the UMLS or BioPortal ontologies can be improved by removing those terms whose dominant syntactic types are not noun phrases. In addition, by focusing on removing the most frequent terms, the precision of feature-extraction based on dictionary based concept recognizers can be improved. For example, terms, such as ‘study,’ ‘treatment,’ ‘patients,’ or ‘results,’ have little value as features for data-mining.

An Annotator Web service provides a mechanism to create annotations for curation, data integration, and indexing workflows, using any of several hundred ontologies in BioPortal. Running the Annotator Web service on appropriate large corpora of text, expected frequencies of ontology terms can be created to perform “omics” style disease enrichment analysis on medical records data.

The NCBO Resource Index (RI) implements highly scalable methods for ontology-based annotation indexing of distributed biomedical data sources. By analyzing the number of annotations per term and characteristics of the ontology hierarchy, the creation time for the RI, a database of 16.4 billion annotations, an embodiment of the present invention was optimized to perform certain analyses in under an hour where prior techniques could have taken over a week.

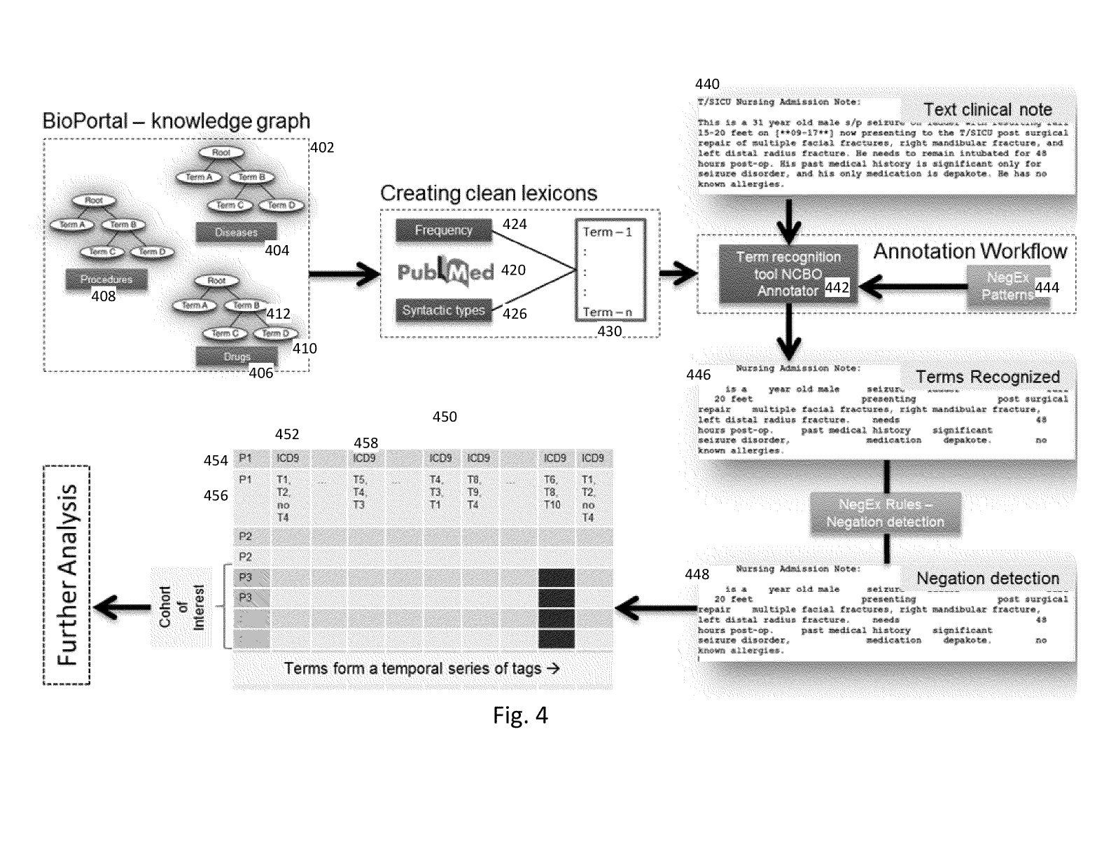

An embodiment of the present invention includes an annotation pipeline as shown in FIG. 4. The annotation pipeline of the present invention enables the use of the knowledge graph formed by the public biomedical ontologies (see FIG. 3) for enrichment analysis, disproportionality analysis, and other data-mining methods. In an implementation, annotation analysis of the free-text narrative was performed on electronic medical data from over 9 million medical records at Stanford University to detect a well-known drug safety signal and to identify known off-label usage from the EHR.

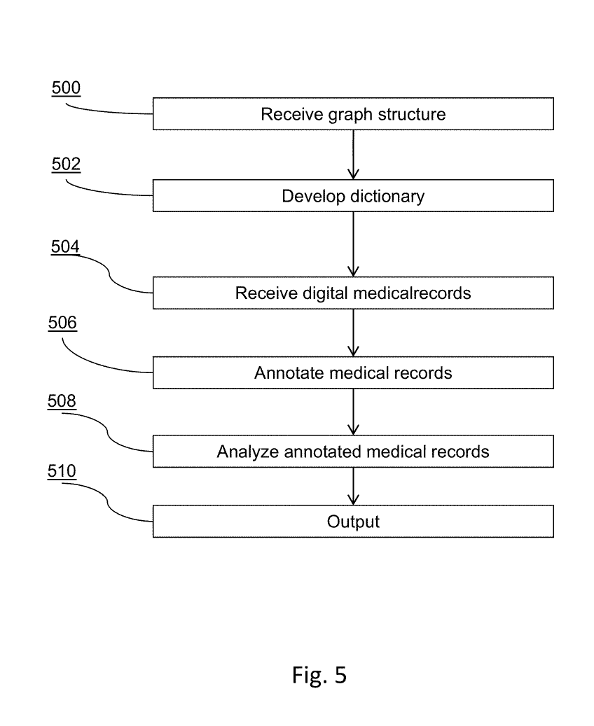

Shown in FIG. 5 is a block diagram of a method for an annotation pipeline according to an embodiment of the invention. The present invention provides a method for incorporating terminologies, ontologies, and contextual annotation in specific domains, such as utilizing biomedical concept hierarchies in data analytics. To do so, at step 500, the method of the present invention receives hierarchical graph information about certain information of interest. For example, as shown in FIG. 4, a method of the present invention receives hierarchical graph information 402 about such concepts of interest that include diseases 404, drugs 406, or procedures 408. Of course, these are just illustrative and the present invention is not limited to only these. Indeed, one of ordinary skill in the art is aware of many other concepts and hierarchies that are appropriate for use in the present invention.

For example, the hierarchies 402 of FIG. 4 can be graph structures that are mathematical structures used to model pair-wise relations (e.g., disease relations) between objects from a certain collection. Graphs can be used to model many types of relations and process dynamics in physical, biological, and social systems. Many problems of practical interest can be represented by graphs. Accordingly, the present invention can be extended to many applications, not just medicine or science.

A graph in the context of the present invention refers to a collection of vertices or nodes (e.g., node 410) and a collection of edges (e.g., edge 412) that connect pairs of nodes. A graph may be undirected, meaning that there is no distinction between the two vertices associated with each edge, or its edges may be directed from one vertex to another.

In an embodiment, the present invention is implemented in a digital computer with flexibility in storing graphs. As known to those of ordinary skill in the art, the data structure used depends on the graph structure and the algorithm used for manipulating the graph with list and matrix structures being available. In any particular application, combinations of list and matrix structures can be used. List structures can be advantageously used for sparse graphs with reduced memory requirements. Matrix structures can provide computational speed but can have large memory requirements. Thus, in application a trade-off analysis should be implemented.

Biomedical ontologies provide essential domain knowledge to drive data integration, information retrieval, data annotation, natural-language processing and decision support. In an embodiment of the invention, ontology and other information is obtained from BioPortal (http://bioportal.bioontology.org). BioPortal is an open repository of biomedical ontologies that provides access via Web services and Web browsers to ontologies developed in OWL, RDF, OBO format and Protégé frames.

In an embodiment of the present invention, a set of application programming interfaces (APIs) as well as Web services are provided that allow other software programs to interface with the present invention. In an embodiment, the present invention includes implementations of common types of uses of the APIs, such as for computationally annotating collections of unstructured textual data and for creating a corpus of annotations from public databases. The present invention includes applicability into data analysis and annotation analytics workflows.

In an embodiment of the invention, public ontologies are integrated through APIs. BioPortal functionality includes the ability to browse, search and visualize ontologies. The Web interface also facilitates community-based participation in the evaluation and evolution of ontology content by providing features to add notes to ontology terms, mappings between terms and ontology reviews based on criteria such as usability, domain coverage, quality of content, and documentation and support. BioPortal also enables integrated search of biomedical data resources such as the Gene Expression Omnibus (GEO), ClinicalTrials.gov, and ArrayExpress, through the annotation and indexing of these resources with ontologies in BioPortal. This and other BioPortal functionality can, therefore, also be integrated into the present invention.

Returning to FIG. 5, at step 502, the method of the present invention develops a dictionary of relevant terms for use in the context of interest. As shown in FIG. 4, the dictionaries can draw from various sources, e.g., PubMed source 420. In general, these sources can have their information structured in various forms and must, therefore, be handled as appropriate. For example, PubMed source 420 may include further information such as frequency 424 and syntactic type 426. This and other information is, in any case, used to build a dictionary of possible terms that may occur in digital medical records. Other sources may include information about semantic types that can also used to build a dictionary of terms. The end result is a useful list of terms 430 that are associated with the graph structures 402.

Turning back to FIG. 5, at step 504 the method of the present invention receives a set of digital medical records to be analyzed. It is, however, important to note that the method of the present invention as shown in FIG. 5 need not be implemented in the order shown. One of ordinary skill in the art will recognize that various steps of FIG. 5 can be done in different orders. Indeed, certain of the steps of the method of FIG. 5 can be performed in parallel or in a pipelined structure.

At step 506, the method of the present invention annotates the medical records using among other things the dictionary of terms 430. For example, in an embodiment of the invention, the received medical records are analyze for the occurrence of the identified dictionary of terms. Also, in an embodiment of the invention, negated occurrences of the identified dictionary of terms are also analyzed.

The annotation of step 506, therefore, provides a structured data set. Indeed this structured data set can be facilitated through the implementation of natural language processing, ontologic annotation, other contextual annotation such as temporal references, and machine learning for data mining. Formulas for enrichment analysis and standard algorithms for machine learning are used in the present invention.

For example, as shown in FIG. 4, digital medical record 440 is input into the method of the present invention and is annotated using a term recognition tool such as NCBO annotator 442. Among other things, annotator 442 is tuned to be responsive to affirmative occurrences of the identified dictionary of terms. The functionality of annotator 442 is supplemented by further being responsive to negated occurrences of the identified dictionary of terms. For example, in an embodiment, negation recognizer tool 444 is implemented using the NegEx tool that is designed as a negation identification tool for clinical conditions. Negation detection allows for the ability to discern whether a term is negated with the context of the narrative (e.g., lack of valvular dysfunction). Thus, in an embodiment of the invention, the method of the present invention identifies affirmative occurrences of identified terms (e.g., terms T1, T3, T7, . . . ) as well as negated occurrences of identified terms (e.g., terms not T5, not T6, not T9, . . . ).

It is important to note that the received medical records may already have their own coded data. In an embodiment of the invention, the annotations of step 506 are supplemented with the received coded data.

In an embodiment of the invention, the digital medical records are no longer used after annotation and extraction of coded data. In this way, the resultant information 446 (after term recognition) and 448 (after negation detection) is devoid of any personal or identifying information. Thus, in an embodiment of the invention, annotation of medical records can be done within the confines of an institution that must abide by strict confidentiality and legal requirements. Once annotated, however, the information can be processed and analyzed by outside entities without fear of breaching confidentialities or violating privacy laws.

Data table 450 shows a representation of the data collected according to the present invention. As shown, information corresponding to individual patients (in a medical context) is shown in column 452. Note that in table 450, two rows are shown for each patient. In this embodiment, a first row, e.g., row 454, corresponds to coded medical data that may be received as part of the digital medical record. A second row, e.g., row 456, corresponds to the annotations developed according to the methods of the present invention. Also, data table 450 includes temporal data in the columns 458. The data in columns 458 is temporal in that a first medical record in time is recorded in a column to the left of another medical record later in time. In an embodiment of the invention, this temporal information can also be used in the analysis of the collected data. In still another embodiment of the invention, temporal information is recorded as a timestamp. Other embodiments are also possible without deviating from the present invention.

Note that data table 450 has no personal identifying information, only medical codes and annotations with certain temporal information. For example, there are no names because such names do not correspond to the dictionary of terms. Also, there are no social security numbers or patient identification numbers for the same reason.

Returning to FIG. 5, at step 508, the information collected in the present invention is analyzed for its content. Many methods and algorithms are known to those of ordinary skill in the art for performing step 508. For example, data mining techniques can be implemented for analyzing the data within data table 450. Recall, however, that the method of the present invention further includes information regarding known graph structures as well as knowledge of the dictionary of terms and further knowledge of the relationship between the annotations. In an embodiment of the invention, use is made of this information so as to provide information about the bottom nodes of a graph structure. Advantageously, because the graph structure is known, the present invention is further able to effectively traverse the graphs so as to provide further information about the upper nodes. Indeed, in an embodiment of the invention, an analysis of the full graph structure is developed.

Returning to FIG. 5, after analysis of the information collected according to the present invention, including the known graph structure, the present invention outputs information of interest at step 510. For example, in a medical context, the present invention can be configured to provide a probability of a particular event of interest given the occurrence of a particular term in the digital medical records. Because the graph structure is known, the present invention can further be configured to provide a probability of a particular event of interest given the occurrence of a class of terms that includes the particular term. Also, the present invention can further be configured to provide a probability of a class of events of interest given the occurrence of a particular term in a medical record. Those of ordinary skill in the art will be aware of many other possibilities for use of the present invention.

In a particular embodiment of the invention, a standalone annotation pipeline was implemented for performing annotations on large data repositories such as the Stanford Clinical Data Warehouse (STRIDE), which contains data on 1.6 million patients, 15 million encounters, 25 million coded ICD9 diagnoses, and a combination of pathology, radiology, and transcription reports totaling over 9.5 million unstructured clinical notes. Processing those clinical notes using the NCBO Annotator Web service would take over 6 months and 800 GB of disk space. In comparison, the standalone annotation pipeline takes 7 hours and 4.5 GB of disk space. The annotation process utilizes the NCBO BioPortal ontology library to identify drug, disease and AE terms in clinical notes using a dictionary generated from the relevant ontologies, such as SNOMED-CT, RxNORM, and MedDRA.

To provide a context for the disclosure of the present invention, an application into the study of adverse drug effects will be discussed starting with some background.

Because the size and characteristics of a target population, duration of use, the concomitant disease conditions, and therapies differ markedly in actual usage conditions, not all safety issues associated with drugs are detected before market approval. The U.S. Food and Drug Administration (FDA) Amendments Act of 2007 requires the FDA to develop a system for using health care data to identify risks of marketed drugs and other medical products. In 2008 the FDA launched the Sentinel Initiative, which would enable the FDA to query diverse healthcare data actively—like electronic health record systems, insurance claims databases, and registries—to evaluate possible medical product safety issues quickly and securely.

Recently, the Observational Medical Outcomes Partnership (OMOP) was designed to establish requirements for a viable national program of active drug safety surveillance by using observational data. But adverse drug events continue to result in significant costs estimated in the billions of dollars annually. It is estimated that roughly 30% of hospital stays have an adverse drug event. Current one-drug-at-a-time methods for surveillance are inadequate because no one monitors the “real life” situation of patients typically receiving three or more concomitant drugs.

Of particular note is the high rate of unintended “blind” interactions resulting from the use of multiple drugs in the context of multiple disease conditions. For example, if an individual has diseases A and B, and is prescribed drug X for disease A and drug Y for disease B, we have an individual who has disease B and is ingesting drug X, resulting in a “blind” interaction between drug X and disease B as well as between drug Y and disease A.

The rates of medication-related adverse events (AEs) are increasing—a trend likely to continue with the aging population, the growth in the number of co-morbidities, and the use of multiple drugs. The present invention, in providing insight into adverse events, provides a valuable tool for improving patient safety and drug efficacy.

For example, given the amount of data in spontaneous reporting systems such as Adverse Event Reporting System (AERS)—which contain voluntarily submitted reports of suspected AEs encountered in clinical practice, the increasing access to electronic health records (EHR), and the increasing online search activity about health issues, a next step as implemented in the present invention is to develop methods for active surveillance that combine the public data (e.g., from AERS and health search logs) with electronic health records for detecting adverse effects of drugs and drug combinations.

The methods of the present invention overcome limitations in the prior art methods, including: issues regarding biases in self-reporting systems (e.g. doctors are more likely to report when clear causality is present, leading to underreporting of complex associations), issues regarding testing in a drug or product centric manner, statistical issues arising from testing large numbers of possible multi-drug combinations, and issues associated with the lack of use of consistent terminologies to combine data sources and to form aggregations of drugs, AEs, and indications.

In an embodiment of the invention for the understanding of adverse events, the critical barriers in current methods are addressed by using unstructured EHR data in combination with AERS and health search data (to compensate biases in each data set), testing in a patient-centric manner to identify multi-drug AEs; and using the aggregations provided by existing public ontologies for drugs, diseases and adverse events to combine data sources as well as to reduce multiple testing. This embodiment provides significant cost savings as well as a significant improvement in patient safety.

Off-label usage of drugs—the prescription of a medication in a manner different from that approved by the FDA—is legal and common in the United States; however, such usage is often done in the absence of adequate scientific evidence. For example, from 2000 to 2008, the off-label use of recombinant factor VIIa (rFVIIa)—which is approved for hemophillia—increased about 140-fold in hospitals. Roughly 97% of the rFVIIa used in an inpatient setting was for indications other than hemophilia and for which there was almost no scientific support. Studies have shown that off-label use accounts for up to 21% of all prescriptions and that most off-label drug uses (73%) have little or no scientific support.

Off-label use is closely tied to safety and adverse drug events because when a drug is used off-label, its safety profile is not known. An embodiment of the invention provides a data-driven safety profile for drugs used off-label. Also, the present invention can identify those off-label uses and drug-combinations that are unsafe, for example, in terms of their adverse drug events profile.

An embodiment of the present invention combines datasets that capture complimentary dimensions about drug safety profiles:
the HER that contain the observed data,
the AERS that contain the reported data,
health search logs that are a proxy for what patients worry about, and
physicians' query logs that show what doctors are concerned about.

The use of these diverse sources can compensate for biases in the individual data sets. For example, AERS suffers from limitations such as duplication of reports, variation in granularity, under reporting, and media influences. The use of EHR data as a source of the expected frequency distribution of drug related adverse events (AEs) can compensate for duplication, under reporting, as well as media biases.

The present invention jointly addresses drug-safety surveillance and safety of off-label usage. Given the interplay between the costs associated with drug-related adverse events and the high rate of “blind” interactions resulting from the use of multiple drugs, it is important to study these problems jointly as in embodiments of the present invnetion.

The present invention provides patient-centric and data-centric methods as opposed to the drug-centric approaches of the prior art. Whereas prior art approaches may may take a per-drug or drug-combination view in searching for the presence of an unexpectedly high number of reports of a given AE for a drug product, the present invention can search on a patient-cohort basis by looking for populations that have an unexpectedly high number of AEs. In this way, cohorts of patients can be identified that are at increased risk of getting AEs based on the drugs they take and the co-morbid conditions they have to discover the AE profile of drug combinations.

Embodiments of the present invention are data-oriented by first analyzing the distribution of drugs and disease co-occurrence in our datasets, and subsequently combining that information with the ontology hierarchies as well as the inter-ontology relationships (e.g., the manner in which drug A “may_treat” disease B). Using the present invention, sets of multi-drug combinations that are most worth testing can be identifie and an AE profile can be constructed. As a result, it is only necessary to test those combinations that identified using the present invention.

In an embodiment, “omics” style enrichment analysis is applied on EHR, AERS, and health logs data. Enrichment analysis (EA) is used to determine whether Gene Ontology (GO) terms associated with a particular biological process, molecular function, or cellular component are over- or under-represented in the set of genes deemed significant in data from microarray experiments. EA is applied to EHRs to detect significant associations among diagnoses. Enrichment analysis is applied to profile the disease associations of aging related genes. EA is closely related to disproportionality-based measures of drug safety signal detection, which quantify the difference between observed and expected rates of particular drug-AE pairs. The advantage of using EA is that the handling and estimation of false discovery rates (FDR) in EA is understood.

In an embodiment, abstraction hierarchies from existing ontologies for drugs, diseases, and adverse events are used to combine datasets and to detect signals that are not seen at the level of leaf nodes in an ontology.

The effectiveness of another embodiment of the invention was tested by attempting to detect a known drug safety signal. More particularly, the effects of Vioxx were examined to demonstrate that unstructured clinical notes processed according to the teachings of the present invention have enough signal to detect drug-AE associations.

Adverse drug events currently result in significant costs: researchers estimate that adverse events occur in over 30% of hospital stays and 50% of these are drug-related events that result in tens of billions of dollars in associated costs per year. In 2004, Vioxx (rofecoxib) was taken off the market because of the increased risk of heart attack and stroke in patients who were taking the drug as a treatment for rheumatoid arthritis (RA). This case in particular generated public outcry and an appeal for better adverse drug event (ADE) detection mechanisms largely because Vioxx was on the market for four years despite murmurings of its side effects. In the past, Fen-Phen (fenfluramine/phentermine) was on the market with serious side effects for more than 24 years and resulted in one of the largest legal settlements ($14 billion) in US history.

To improve post-market drug safety, Congress passed the U.S. Food and Drug Administration (FDA) Amendments Act of 2007, which mandated that the FDA develop a national system for using health care data to identify risks of marketed drugs and other medical products. The FDA subsequently launched the Sentinel Initiative in 2008 to create mechanisms that integrate a broader range of healthcare data and augment the agency's current capability to detect ADEs on a national scale. In related efforts, organizations like the Observational Medical Outcomes Partnership have been established to address the use of observational data for active drug safety surveillance.

The current paradigm of drug safety surveillance is based on spontaneous reporting systems, which are databases containing voluntarily submitted reports of suspected adverse drug events encountered during clinical practice. In the USA, the primary database for such reports is the Adverse Event Reporting System (AERS) database at the FDA. The largest of such systems is the World Health Organization's Programme for International Drug Monitoring. Researchers typically mine the reports for drug-event associations via statistical methods based on disproportionality measures, which quantify the magnitude of difference between observed and expected rates of particular drug-event pairs.

Partly in response to the biases inherent in data sources like the AERS or billing and claims databases, researchers are increasingly incorporating observational data directly from hospital electronic health record (EHR) databases as well as published research from Medline abstracts to detect ADEs. Recent advances on these methods include identifying combinations of drugs that may lead to combinations of adverse events, and more closely address the real-life situation of patients taking multiple drugs concomitantly. Given advances in detecting (e.g., discovering or inferring) drug safety signals from the AERS, it becomes crucial to develop methods for testing (e.g., searching for or applying) these signals throughout the EHR.

Despite the potential impact on improving patient safety, the full benefit of the EHR remains largely unrealized because the detailed clinical descriptions buried within the clinical text noted by doctors, nurses, and technicians in their daily practice are not accessible to data-mining methods. Methods that rely on data encoded manually could be missing more than 90% of the adverse events that actually occur. Fortunately, given advances in text processing tools, researchers can now computationally annotate and encode clinical text rapidly and accurately enough to address real-world medical problems like ADE detection.

Using biomedical terminologies goes hand-in-hand with making the most of clinical text. Terminologies contain sets of strings for millions of terms that can be used as a lexicon to match against clinical text. Moreover, each terminology specifies relationships among terms and often includes a classification hierarchy. For example, the National Center for Biomedical Ontology (NCBO) BioPortal repository contains about 300 terminologies and 5.4 million terms, including many from the Unified Medical Language System4 (UMLS). By linking patients and their clinical text to multiple terminologies via these lexical matches, researchers can make inferences that are not possible when using a single classification hierarchy alone.

An embodiment of the present invention improves the predictive ability of surveillance efforts by making use of automated inference over drug families, diseases hierarchies, and their known relationships such as indications and adverse events for drugs. For example, Baycol (cerivastatin), a drug for treating patients with high-cholesterol, was recalled in 2001 for increased risk of rhabdomyolysis, a muscle disorder that can lead to kidney failure and possibly death. By reasoning over the known relationship between myopathy and rhabdomyolysis that is encoded in standard biomedical terminologies like MedDRA and SNOMED-CT, researchers could have automatically inferred the adverse relationship between myopathy and cerivastatin and prevented 2 years of unmitigated risk for other patients. In other words, terminologies make it possible to integrate and to aggregate resources automatically not only by recognizing a lexicon of terms from many different vocabularies, but also by assimilating information at different levels of specificity among those vocabularies.

An embodiment of the present invention implements methods that annotate and mine the clinical text of a large number of patients for testing drug safety signals. To validate an embodiment of the present invention, a well-known signal was tested by annotating the clinical text of more than one million patients from the Stanford Clinical Data Warehouse (STRIDE) and computing the risk of getting a myocardial infarction for rheumatoid arthritis patients who took Vioxx.

It has been shown that patients having Rheumatoid arthritis (RA) who took Vioxx (rofecoxib) showed significantly elevated risk (Adjusted Odds Ratio=1.34) for myocardial infarction (MI). These effects resulted in the drug being taken off the market. To reproduce this risk, we identified patients in the STRIDE data who had the given condition (RA), who were taking the drug, and who then suffered an adverse event prior to 2005.

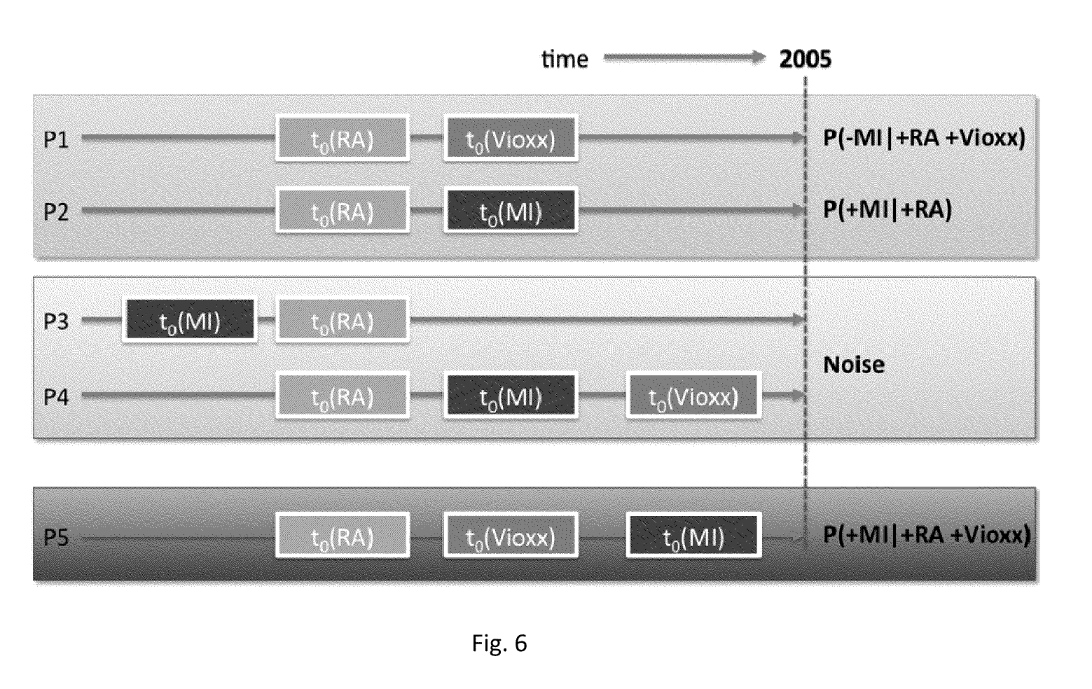

To identify patients with RA and MI, the structured data (e.g., the ICD9 coded diagnoses) was queried for the ICD9 codes for RA and MI as well as the normalized annotations of the unstructured data, to look for non-negated mentions of MI and RA. The first occurrence or mention of the condition was coded as t0(RA) and t0(MI) as shown in FIG. 6. The normalized annotations of the unstructured data were then queried to look for non-negated mentions of Vioxx or rofecoxib. We denoted the first occurrence or mention of the drug as t0(Vioxx) as shown in FIG. 6.

The test was conducted with the temporal constraints taken into consideration. From the patient counts, a contingency table was constructed as shown in Table 1. The reporting odds ratio (ROR) and the proportional reporting ratio (PRR) were calculated according to known methods (e.g., see Bate, A. and S. J. W. Evans, Quantitative signal detection using spontaneous ADR reporting. Pharmacoepidemiol Drug Saf, 2009. 18(6): p. 427-36). A ROR of 2.06 was obtained with a confidence interval (CI) of [1.80, 2.35]; and PRR of 1.82 with CI of [1.65, 2.03]. The uncorrected X2 statistic was significant with a p-value <10−7. In contrast, using just the coded ICD9 data, the ROR is 1.52 with a CI of [0.87, 2.67] and a p-value of 0.068. This data is, therefore, consistent with the known adverse effects of Vioxx. This result demonstrates that it is possible to analyze annotations of clinical notes for detecting drug safety signals.

TABLE 1
Contingency table for Vioxx and Myocardial infarction within
the STRIDE data.

| Patients with RA | | | |
|---|---|---|---|
| before 2005 | MI | No MI | Total |
| Vioxx | a = 339 | b = 1221 | (a + b) = 1560 |
| No Vioxx | c = 1488 | d = 11031 | (c + d) = 12519 |
| Total | 1827 | 12252 | 14079 |

In another embodiment, the drug Avastin (bevacizumab) was used to show that the present invention can be used to discover off-label usage: Avastin is approved by the FDA for a variety of cancers including carcinoma of the lung, glioblastoma, astrocytoma, and renal neoplasms. The normalized annotations of the STRIDE data were analyzed to identify all patients having non-negated mentions of the drug in their records. The first and last occurrence of the drug were noted. Then, using a window of seven days around that timeframe, all non-negated diseases mentioned for those patients was counted. Using the disease counts, enrichment analysis (see Lependu, P., M. A. Musen, and N. H. Shah, Enabling enrichment analysis with the Human Disease Ontology. Journal of biomedical informatics, 2011) was performed to identify those diseases that co-occurred significantly more with Avastin than expected by chance given the frequency of those diseases in the entire dataset.

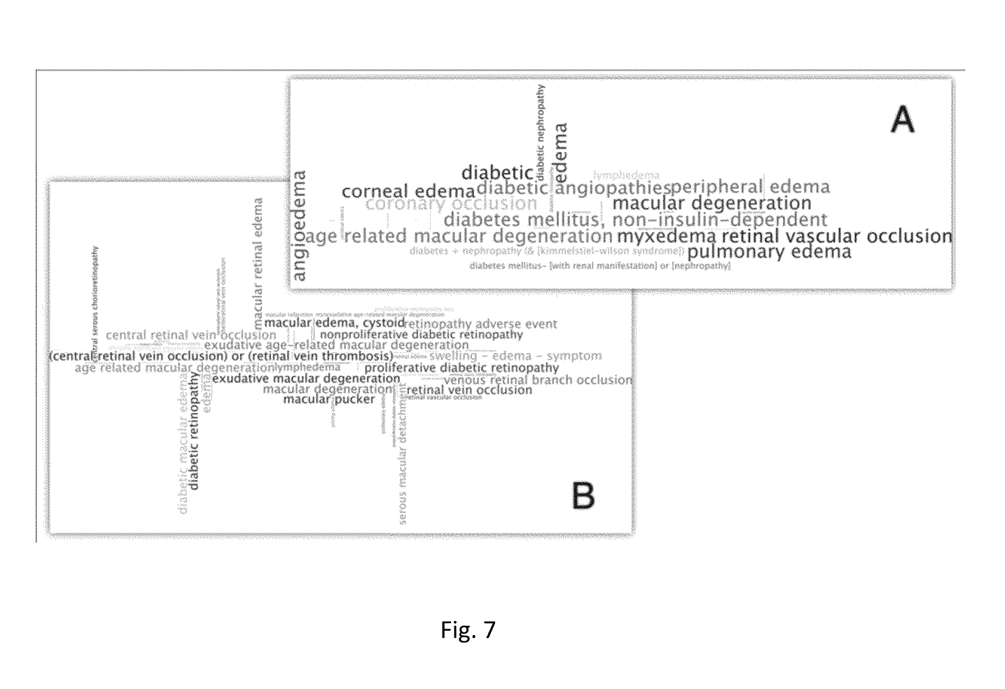

The entire analysis was performed twice. The first time, preferred names and synonyms were mapped to term classes—this result is visualized in FIG. 7(B) where diseases that are significantly associated with Avastin are shown in larger font sizes.

The second time, the knowledge graph from BioPortal, which collapses terms classes further by using ontology hierarchies, relationships, and inter-ontology term mappings were used. As shown in FIG. 7(A), the off-label usage signal becomes amplified and clearer when using the BioPortal knowledge graph. The diseases associated with Avastin—putative off-label usages—were validated by comparing against known off-label usage from Micromedex where Avastin is shown to be used off-label for macular degeneration, macular edema, diabetic retinopathy, central vein occlusion, and diabetic angiopathies. The results from an embodiment of the invention show that putative off-label usage can be found by annotation analysis on EHR data.

By looking for patterns at coarser levels in an ontology (i.e., a few steps up the ontology hierarchy), the amount of data that can support a specific association can be increased. By normalizing the drug and disease names, data across is integrated across multiple sources to reduce the number of combinations needed to be tested, making the search computationally tractable and reducing multiple hypothesis testing.

Temporal negations are statements that, for instance, assert that: Patient P1 no longer has condition C1, (i.e. that the patient has either gotten better, or gotten worse, but in any case it is no longer the case that C1 applies). Temporal negations provide endpoints for our analyses. Categorical negations are statements such as condition C1 is ruled out, implying that C1 was a preliminary diagnosis, and that the patient had something else all along. This something else must then be determined, and, once determined, propagated back to the earliest timestamp associated with the (now ruled out) assignment of C1. As a first cut, the set of NegEx regular expressions can be grouped into two subsets: one to detect temporal negations and one to detect categorical negations.

Making the search for multi-drug combinations tractable: Within the public biomedical ontologies, there are roughly half a million text strings for diseases and about the same number for drugs—e.g., acetaminophen has 1700 different names. After using the knowledge graph of the present invention to normalize the alternative names as well as resolve multi ingredient drugs to their constituents, 11,107 unique drugs and 3,594 unique diseases are a result. Even for this reduced set of drugs and diseases, there re 1.76×1021 unique 3-drug, 3-disease combinations.

To be described now are further details regarding using embodiments of the present invention to analyze the use of Vioxx and the risk of myocardial infarctions that is useful in illustrating broader applications of the present invention.

To reproduce this risk using an embodiment of the present inventon, patients were identified in the EHR who have the given condition (RA), who are taking the drug, and who suffer the adverse event. In this embodiment, methods described with reference to FIGS. 4 and 5 were implemented. It should be noted that as will be described further the further analysis described with reference to FIGS. 4 (e.g., “Further Analysis”) and FIG. 5 (e.g., steps 508 and 510) will be illustrated further below. Indeed, such further analysis can include normalization, data mining, and reasoning services, among other things.

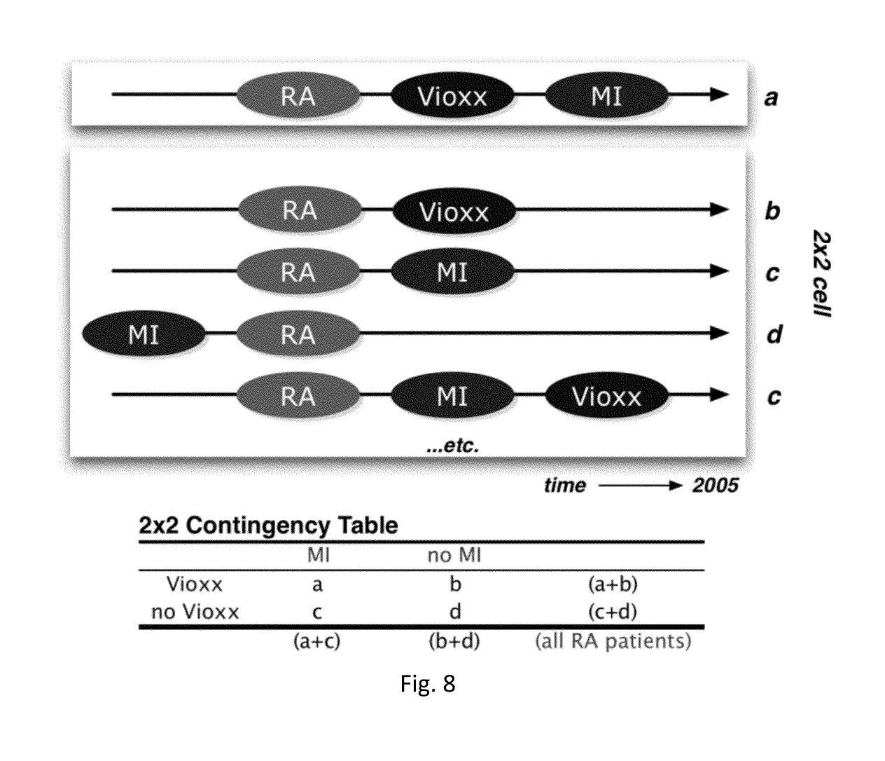

In the presently described embodiment, only records before 2005 were reviewed because Vioxx was discontinued subsequently. From the observed patient counts, a contingency table was constructed as shown in Table 1 and the odds ratio (OR) was calculated as described in further below with reference to Table 4. The test was conducted with the expected temporal constraints taken into consideration, as depicted in FIG. 8.

As shown in FIG. 8, condition a is the situation of observed events RA→Vioxx (i.e., rofecoxib)→MI; condition b is the situation of observed events RA→Vioxx; condition c is RA→MI; condition d is MI→RA. The 2×2 contingency table as shown in FIG. 8 can then be constructed for these contingencies as well as the contingencies a+b, c+d, a+c, b+d, and all RA patients as shown in FIG. 8. From the data set used, the data shown in Table 1 was found.

In this embodiment, data was used from the Stanford Clinical Data Warehouse (STRIDE), which is a repository of 17-years worth of patient data at Stanford University. It contains data from 1.6 million patients, 15 million encounters, 25 million coded ICD9 diagnoses, and a combination of pathology, radiology, and transcription reports totalling over 9.5 million unstructured clinical notes. After filtering out patients to satisfy HIPAA requirements (e.g., rare diseases, celebrity cases, mental health), 9,078,736 notes were annotated for 1,044,979 patients. The gender split was roughly 60% female, 40% male. Ages range from 0 to 90 (adjusted to satisfy HIPAA requirements), with an average age of 44 and standard deviation of 25.

The annotator workflow according to an embodiment of the invention (see for example, FIGS. 4 and 5) was used. As implemented here, the annotator workflow further included the normalization, mining and research services as part of the further analysis shown in FIGS. 4 and 5. The annotator workflow in this embodiment annotates clinical text from electronic health record systems and extracts disease and drug mentions from the EHR.

Unlike natural language processing methods that analyze grammar and syntax, the annotator workflow according to an embodiment of the invention is a system that extracts terms. For example, an embodiment uses biomedical terms from the NCBO BioPortal library and matches them against input text. In an embodiment of the invention, the annotator workflow incorporates the NegEx algorithm to incorporate negation detection—the ability to discern whether a term is negated within the context of the narrative. In another embodiment, the present invention can discern additional contextual cues such as family history versus recent diagnosis.

A strength of the annotator workflow of the present invention is the highly comprehensive and interlinked lexicon that it uses. It can incorporate the NCBO BioPortal ontology library of over 250 ontologies to identify biomedical concepts from text using a dictionary of terms generated from those ontologies. Terms from these ontologies are linked together via mappings. In an embodiment, the workflow was configured to use a subset of those ontologies (see Table 2 below) that are most relevant to clinical domains, including Unified Medical Language System (UMLS) terminologies such as SNOMED-CT, the National Drug File (NDFRT) and RxNORM, as well as ontologies like the Human Disease Ontology. The resulting lexicon contains 2.8 million unique terms.

TABLE 2
Subset of ontologies

| Ontology Name | Source | Abbreviation | Frequency |
|---|---|---|---|
| Current Procedural Terminology | UMLS | CPT | 17243153 |
| Human Disease Ontology | OBO | DO | 122035173 |
| International Classification of | UMLS | ICD10 | 55572189 |
| Disease (ICD-10) | | | |
| International Classification of | UMLS | ICD9 | 58334369 |
| Disease (ICD-9) | | | |
| Logical Observation Identifier | UMLS | LNC | 1208284117 |
| Names and Codes | | | |
| Medical Dictionary for | UMLS | MDR | 361398956 |
| Regulatory Activities | | | |
| Medical Subject Headings | UMLS | MSH | 643026014 |
| National Drug File | UMLS | NDFRT | 232557746 |
| NCI Thesaurus | UMLS | NCI | 2498591490 |
| Online Mendelian Inheritance in | UMLS | OMIM | 262747872 |
| Man | | | |
| Systematized Nomenclature of | UMLS | SNOMEDCT | 2369959351 |
| Medicine-Clinical | | | |

Another strength of embodiments of the present invention is its speed. The workflow can be optimized for both space and time when performing large-scale annotation runs. For example, in an embodiment, it takes about 7 hours and 4.5 GB of disk space to process 9 million notes from over 1 million patients. Furthermore, an embodiment conveniently fits on a USB Flash drive and takes 45 minutes to configure and launch on a computer system. Existing NLP tools do not function at this scale.

In an embodiment, the output of the annotation workflow is a set of negated and non-negated terms from each note (see, e.g., 4 (450) and FIG. 5 (step 506)). As a result, for each patient, a temporal series of terms mentioned in the notes is obtained.

An embodiment also includes manually encoded ICD9 terms for each patient encounter as additional terms (see FIG. 4). Because each encounter's date is recorded, each set of terms can be ordered for a patient to create a timeline view of the patient's record. Using the terms as features, patterns of interest can be defined (such as patients with rheumatoid arthritis, who take rofecoxib, and then get myocardial infarction), which can be used in data mining applications.

In an embodiment, the RxNORM terminology was used to normalize the drug having the trade name Vioxx into its primary active ingredient, rofecoxib. From the set of ontologies used, an annotator according to an embodiment of the invention identifies all notes containing any string denoting this term as either its primary label or synonym. Other ontologies are used to normalize strings denoting rheumatoid arthritis or myocardial infarction and the annotator workflow identifies all notes containing them.

As an option in another embodiment, reasoning can be enabled to infer all subsumed terms, which increases the number of notes that can be identified beyond pure string matches. For example, patients with Caplan's or Felty's syndrome may also fit the cohort of patients with rheumatoid arthritis. Notes that mention these diseases can automatically be included as well even though their associated strings look nothing alike. Such reasoning was not implemented in the results reported further below.

Patient visits include in some cases the discharge diagnosis in the form of an ICD9 code. The ICD9 codes for rheumatoid arthritis begin with 714 and the ICD9 code for myocardial infarction begins with 410. In the embodiment being described here, these manually encoded terms were included as part of the analysis as a comparison against what is found in the text itself.

An odds ratio (OR) is a measure commonly used to estimate the relative risk of adverse drug events. The ratio gives one measure of disproportionality—the unexpectedness of a particular association occurring given the all other observations. A method for calculating the OR as implemented in an embodiment of the invention is summarized in Table 3.

TABLE 3
Calculating odds ratio

| | y | not y |
|---|---|---|
| x | a | b |
| not x | c | d |

In the presently described embodiment, the OR measure was used to infer the likelihood of an outcome like myocardial infarction when the population exposed to a drug like Vioxx is considered versus those who are not exposed. Rather than use the entire set of one million patients as the background population, in an embodiment, the analysis was restricted to the subset of patients who demonstrate the usual indication, which for Vioxx would be rheumatoid arthritis. Applying this restriction ensures that patients who have zero propensity to be exposed to Vioxx do not get included in the analysis and avoids biasing the result.

Patients are considered to be exposed (cells a and b in Table 3) only if their record demonstrates that the very first mention of Vioxx follows a mention of rheumatoid arthritis based on the ordering of timestamps for the notes in which the terms were found. The idea is that the patient should most likely be receiving Vioxx as a treatment for arthritis. Likewise, patients are considered to be experiencing the adverse event (cells c and d in Table 3) if myocardial infarction follows mentions of arthritis. Finally, those patients who potentially get myocardial infarction as a result of taking Vioxx (cell a in Table 3) require that myocardial infarction follows Vioxx (which follows arthritis) in the notes. FIG. 2 illustrates several of the patterns of interest that contribute to each cell of the contingency table.

Using this method according to an embodiment of the invention, it was confirmed that mentions of Vioxx (rofecoxib) demonstrate a significantly associated risk for myocardial infarction (MI) in patient clinical notes mentioning rheumatoid arthritis (RA) before 2005. Analysis of the 2×2 contingency matrix (Table 1) for the association between rofecoxib and MI results in an odds ratio of 2.06 with confidence interval 1.80-2.35 and p-value less than 10-7 using Fisher's exact test (two-tailed). This confirms an elevated risk of having mentions of myocardial infarction follow mentions of Vioxx.

In contrast, using coded discharge diagnoses (ICD9 codes) without any clinical text, the same patient records demonstrate no significant risk—odds ratio is 1.52 with confidence interval 0.87-2.67 and p-value 0.19 (Table 2).

TABLE 3
Results from ICD9 analysis

| | myocardial | no myocardial |
|---|---|---|
| | infarction | infarction |
| rofecoxib | a = 16 | b = 487 |
| no rofecoxib | c = 61 | d = 2831 |

In addition to testing for the rheumatoid arthritis-Vioxx-myocardial infarction signal, the signals for diabetes-Actos-bladder neoplasm (odds ratio 1.51, p-value <10−7), and hypercholesterolemia-Baycol-rhabdomyolysis (odds ratio 7.65, p-value 2.05×10−4) were also tested.

Results obtained in testing embodiments of the present invention confirm that it is possible to validate risk signals for some of the most controversial drugs in recent history by analyzing annotations on clinical notes.

These results depend upon the efficacy of the annotation mechanism. A comparative evaluation of two concept recognizers used in the biomedical domain (Mgrep and MetaMap) was conducted. It was found that Mgrep has advantages in large-scale, service-oriented applications specifically addressing flexibility, speed and scalability. The NCBO Annotator uses Mgrep. The precision of concept recognition varies depending on the text in each resource and type of entity being recognized: from 87% for recognizing disease terms in descriptions of clinical trials to 23% for PubMed abstracts, with an average of 68% across four different sources of text.

In other embodiments of the present invention, samples of patient records are examined to validate the ability to recognize diseases in clinical notes. Sampling can alos be used to evaluate the accuracy of annotation workflows according to the present invention when applied to very large datasets.

In embodiments of the present invention, a goal is to explore methods that work for detecting signals at the population-level and not necessarily at an individual level. In contrast with using a full-featured natural language processing (NLP) tool, embodiments of the present invention present simple, fast, and good-enough term recognition methods that can be used on very large datasets. NLP tools do not presently function at the scale of tens of millions of clinical notes. If such tools do reach the necessary level of scalability, they can be used in conjunction with the methods of the present invention to provide a system with enhanced functionality.

In another embodiment of the present invention, contextual cues (e.g., family history) are used by incorporating tools like ConText as a means of improving the precision with which it can be determined whether a drug is prescribed or a disease is diagnosed. Regular expression based tools like Unitex that demonstrate the kind of speed and scalability required while adding more powerful pattern recognition features like morpheme-based matching can also be used with embodiment of the present invention.

Given the level of noise that can be expected with automated annotation, signal detection according to embodiments of the present invention remains robust. For example, cell a in the contingency table (Table 3) should be as accurate as possible. Assuming a 20% false positive rate, the likelihood of getting cell a wrong is very low (0.8%) because all three annotations would need to be overestimated at the same time, which is unlikely. Adjusting all cells in the 2×2 table for a 20% false positive rate still yields a significant odds ratio of 1.43 (confidence interval 1.21-1.68, p-value 4.3×10−5).

On the other hand, ICD9 coding likely results in no signal in the dataset because it severely underestimates the actual likelihood—a patient who has RA may only get coded for treating, say, an ulcer, because of the nature of the billing and discharge diagnosis mechanism, but notes on their history will clearly show that they have RA. There is reasonably confidence that true signals are observed despite some degree of noise.

Another disproportionality measure that has been explored is the use of enrichment analysis techniques adapted from high-throughput analysis of genes. What makes the use of enrichment analysis interesting is that the use of ontologies and the handling of false discovery rates is well studied. As with using propensity score adjustments, one of the key issues is to choose an appropriate background distribution from which to infer that an unlikely scenario has occurred. In some cases, researchers use a control group, such as patients having minor complications. In the presently described embodiment, the background is limited by restricting the cohort to patients with RA.

Embodiments of the present invention can be used to detect new drug safety signals given patterns that have not yet been reported. When conducting such analysis, it is important to control for the false discovery rate of new signals and prioritize new signals that may be worth testing. In addition, to manually reviewing patient records for annotation accuracy, a combination of data sources like AERS and the Medicare Provider Analysis and Review data can be used for cross-validation.

Ontologies play two vital roles in the workflow of embodiment of the present invnetion: 1) they contribute a vast and useful lexicon; and 2) they define complex relationships and mappings that can be used to enhance analysis. Although using ontologies for normalization and aggregation are beneficial, they also present a key challenge that arises when using large and complex ontologies. The challenge is to determine which abstraction level to use for reporting results. For drugs, it may be appropriate to normalize all mentions to either active ingredients or generics. With diseases and conditions, it can be challenging to determine what level of abstraction makes the most sense for any given analysis. For example, counting patients with bladder papillary urothelial carcinoma as persons with bladder cancer in the Actos study is probably more useful than aggregating up to the level of urinary system disorder. But if it is desired to know what diseases are most frequently co-morbid with patients having bladder cancer, then the number of related diseases and all of their more specific kinds creates an increase in the number of combinations to consider.

In an embodiment of the invention, information theory—including, information content—can be used to partition the space of possible abstraction levels into bins that represent similar levels of specificity across the board, which should make the aggregation of results at similar levels of specificity more tractable.

Despite successes in testing a known drug safety signal, when examining drug-disease co-occurrences in clinical notes to discover new adverse events, discerning indications from adverse events (AEs) for a given drug-disease pair remains a challenge.

In another embodiment of the invention, statistically enriched co-occurrences of drug-disease mentions in the clinical notes are used not only to test but also to detect new adverse drug event signals. The ability to distinguish indications from AEs directly in a given drug-disease co-occurrence pair is a first-step towards direct data driven detection of safety signals from unstructured EMR data. Using an embodiment of the present invention described below, it is shown that by using co-occurrence frequencies and by keeping track of the time at which a drug or disease is mentioned, discrimination is achieved between drug-adverse events pairs from drug-indication pairs.

In this embodiment of the present invention, co-occurrence frequency models are built by analyzing over 9-million clinical notes for more than one million patients from the Stanford Clinical Data Warehouse (STRIDE). The patient records include both inpatient and outpatient notes. The records are from 620,946 male patients, 424,060 female patients, and 2330 cases where the sex information is missing. All note types were included in this analysis. In terms of the age distribution, for each 10-year age range from 0 to 70, there are between 90,000 and 170,000 patients in each age range—in terms of age at first visit.

A sample of 1,550 drug-disease pairs was used from Medi-Span® Adverse Drug Effects Database™ (from Wolters Kluwer Health, Indianapolis, Ind.), AERS, and the National Drug File ontology (NDFRT) as gold standard. A support-vector machine (SVM) classifier was trained using the empirical data from STRIDE. Finally, the results were validated against an independent set of drug-indication and drug-AE pairs from the external sources. The classifier performs well in cross-validation (AUC=0.85) and independent validation (AUC=0.846).

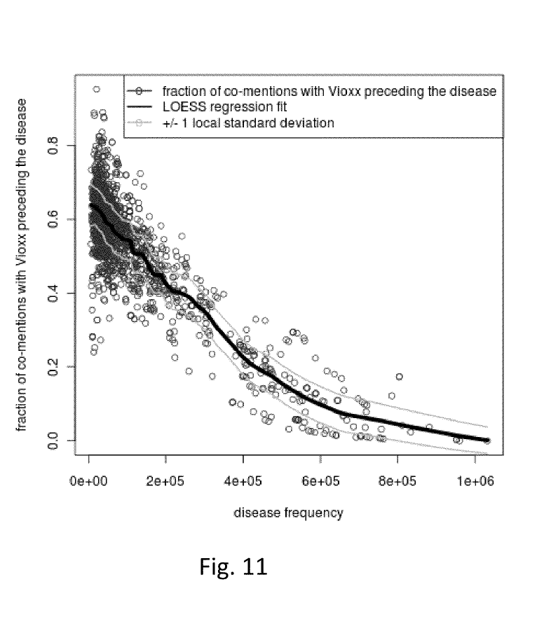

An embodiment of the present invention comprises two broad components: an annotator workflow that annotates textual medical records with relevant drug and disease terms as described above and with reference to FIGS. 4 and 5, for example, and a statistical framework under which the drug-disease pairs were organized and classified (see, e.g., FIGS. 11 and 14). The annotator workflow according to embodiments of the present invention performs an optimized exact string matching which is computationally efficient. Embodiments of the present invention demonstrate that it is possible to distinguish drug-indication pairs from drug-AE pairs.

For a statistical framework according to an embodiment of the present invention, a novel combination of regression and classification techniques are applied to address a handful of basic but salient sources of confounding so as to achieve improved accuracy in discerning drug-AE pairs from drug-indication pairs. Methods based purely on association strength are unable to make that distinction among drug-disease pairs created based on co-occurrence.

FIGS. 4 and 5 and their associated description illustrate the workflow to annotate the clinical text from electronic health record systems and to extract disease and drug mentions from the EHR. An annotator workflow according to embodiments of the present invention was created based upon the existing National Center for Biomedical Ontology (NCBO) Annotator Web Service. The annotator according to an embodiment of the present invention uses biomedical terms from the NCBO BioPortal library and matches them against input text. The annotation process utilizes the NCBO BioPortal ontology library of over 250 ontologies to identify biomedical concepts from text using a dictionary of terms generated from those ontologies.

For this implementation, the workflow was configured to use SNOMED-CT and RxNORM. The resulting lexicon contains 1.6 million terms. Negation detection is based on trigger terms used in the NegEx algorithm (see, e.g., FIG. 4).

The output of the annotation workflow is a set of negated and non-negated terms from each note. As a result, a temporal series of “symbols” or tags is achieved for each patient that comprises terms derived from the notes and the coded data collected at each patient encounter. Because each encounter's date is recorded, each set of terms can be ordered for a patient to create a timeline view of their record. Using the tags as features, patterns of interest can be defined such as patients with rheumatoid arthritis who took rofecoxib and then suffered from myocardial infarction. In the presently described embodiment, a goal is to discriminate the drug-adverse event pairs from the drug-indication pairs.

In an embodiment, for every patient, their notes are scanned chronologically and the first mention of every drug and disease is recorded. Drugs and diseases will re-appear throughout a patient's timeline, yet only first occurrence (denoted T0 for initial time) is recorded. All subsequent mentions of the noted term are ignored. This simplifies computation and captures the temporal ordering between the first mentions of drugs and diseases.

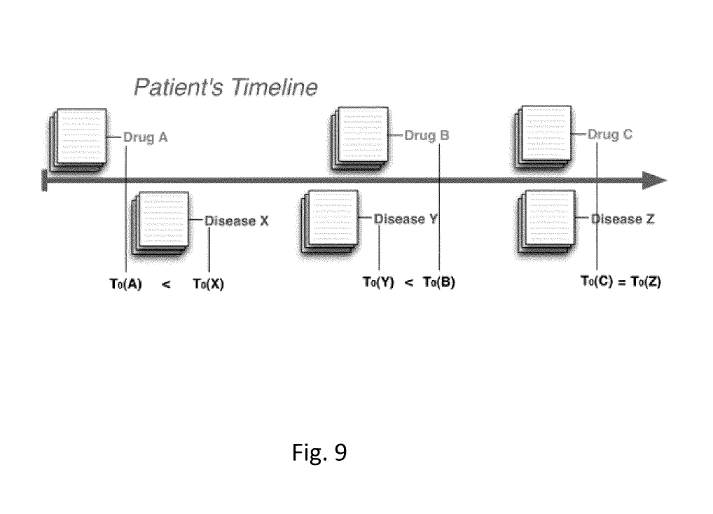

For the brevity of subsequent explanations, two terms are introduced: co-mentions and drug-first fractions. For any drug-disease pair, the co-mention count is the number of distinct patients for whom both the drug and disease are mentioned in their record—in any chronological order. For such co-mentions, there is one first-mention for the drug and one first-mention for the disease in a patient's record. There are three possible cases for each drug-disease pair when examining the first mentions in a single patient's record as shown in FIG. 9: either the drug is mentioned before the disease (e.g., T0(A)<T0(X)), or the disease is mentioned before the drug (e.g., T0(Y)<T0(B); or the drug and the disease are mentioned at the same time (e.g., T0(C)=T0(Z).

A fraction of the patients will support the first case: where the first mention of the drug precedes the first mention of the disease. The numerical fraction of patients with this specific temporal ordering is defined as the drug-first fraction for a particular drug-disease pair. The drug-first fraction characterizes the temporal ordering between the first mentions of the drugs versus the first mentions of the diseases. In a finding of the present invention, it was shown that disproportionalities in the counts of co-mentions and the drug-first fractions will sufficiently characterize drug-disease pairs to classify them into drugs-AEs and drug-indications.

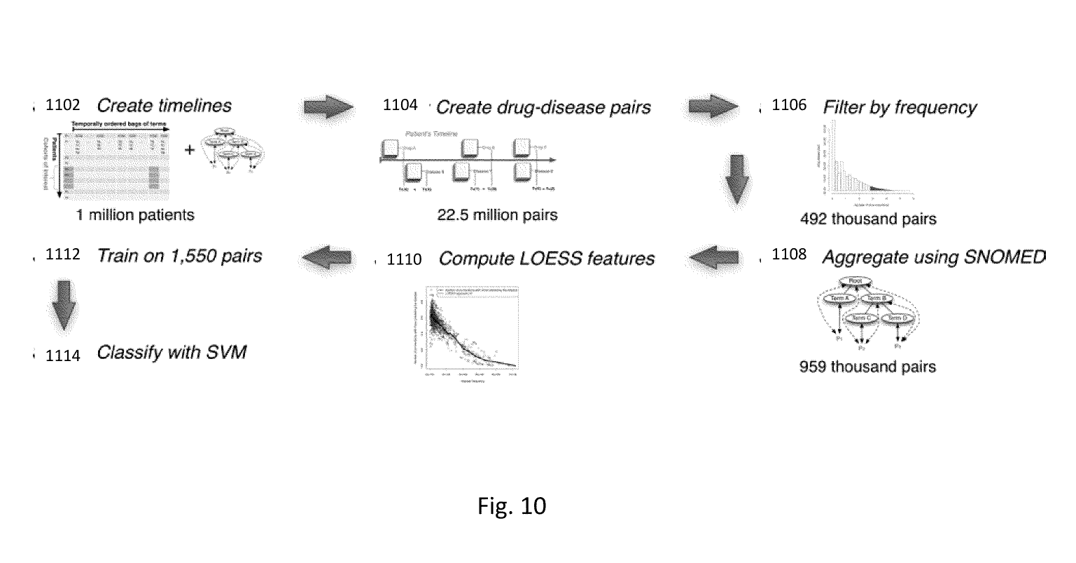

FIG. 10 illustrates a method according to an embodiment of the present invention. As shown, at step 1102, patient timelines are created such as described with reference to FIGS. 4 and 5. At step 1104, drug-disease pairs and their frequency are created such as discussed with regard to FIG. 9. At step 1106, the results of step 1106 are filtered by frequency (e.g., frequencies greater than 1000) and then aggregated using the SNOMED hierarchy at step 1108. Statistics including LOESS features are then calculated at step 1110. A training process is then implemented at step 1112. Steps 1110 and 1112 are used to generate features. In an embodiment, the training process trained on 1550 drug-disease pairs. Finally, at step 1114, classification is performed with SVM that classifies whether the disease in a given drug disease pair is an indication or adverse event. Details of these various steps will be described further below.

To reduce the computation load, the drug and disease terms are normalized early on in the analysis workflow, as shown in step 1102 of FIG. 10. For drugs, they are normalized into ingredients using RxNORM relations like “has_ingredient.” In many cases, such as rofecoxib, drugs contain only one ingredient. Alternatively, multiple drugs may share a common ingredient, and multiple ingredients may be present in a single drug. For example, Excedrin has acetaminophen, aspirin, and caffeine, whereas Midol Complete has acetaminophen, caffeine, and pyrilamine maleate. Although drug normalization is a many-to-many mapping, ultimately, the resulting number of unique ingredients in subsequent analysis is smaller. In subsequent analysis, ingredient-disease pairs are compared. In the analysis and interpretation of indications and adverse events, drug ingredients are treated as drugs.

In addition to normalizing drugs, diseases are also normalized. Using UMLS-provided “source-stated synonymy” relations, multiple disease terms are normalized into a single disease concept. Disease normalization constitutes a many-to-one mapping. Being part of UMLS, SNOMED-CT provides a subsumption hierarchy via “is-a” relations. Specialized child concepts (e.g., malignant melanoma) relate to their generalized parent concepts (e.g., malignant neoplasm) via this relation. When a specific child concept appears in text, that mention is counted as a mention of that concept's parent terms. Using such hierarchical relations, aggregation is performed by accepting mentions of a child concept when searching for mentions of an ancestor concept—a process called computing the transitive closure of the concept counts over the is-a hierarchy. Materializing this closure is computationally intensive, so an optimization for speed is performed: when a disease concept is never mentioned in STRIDE, that disease concept is excluded from being considered further. It has been shown that the majority of UMLS concepts do not appear in clinical text and that by removing them from the present analysis, computational efficiency is achieved.

From over 9 million notes, 29,551 SNOMED-CT diseases and 2,926 drug ingredients were detected, resulting in 86.5 million possible drug-disease pairs. Only 22.5 million actually occur in the data (see step 1104 of FIG. 10). For an embodiment of the present invention, only pairs that occur in at least a thousand patients were considered, which reduces the set to 492,115 pairs (see step 1106 of FIG. 10). After aggregation is performed based on SNOMED-CT (see step 1108 of FIG. 10), the count of pairs grows to 986,850 because of inclusion of general terms in the drug-disease pairs. These 986,850 pairs constitute the basis for further discussion below. It is obvious to those of ordinary skill in the art that many variations of the disclosed invention are possible. For example, the threshold for drug disease pairs can be changed.

While the ROR is the traditional measure for disproportionlity, it does not necessarily fully capture temporal ordering, which is necessary in discerning an adverse event from an indication. Moreover, RORs assume independence, which is too restrictive; confounding factors can affect the frequencies of co-occurrences as well as temporal ordering. For example, neonatal diseases will appear disproportionately in the earlier parts of the medical record such that temporal associations made subsequently as an adult will be skewed. To compensate, local regression (LOESS) models are fitted to define baselines, substituting for the commonly used independence assumption (see step 1110 of FIG. 10).

As an example, suppose it is desired to calculate the drug-first fraction of Vioxx versus myocardial infarction (MI). There is an observed drug-first fraction from the STRIDE data. Then, fixing the disease (MI) for every drug X in the vocabulary associated with MI, each drug-first fraction (X-MI) measured against the overall frequencies of each drug is counted. A locally weighted smoothing regression (LOESS) is fit across all X-MI pairs (from the 986,850 pairs) to estimate the drug-first fraction for Vioxx-MI. This estimate serves as an expected value, which represents the null hypothesis that drugs with frequencies similar to Vioxx would have similar drug-first fractions against MI. Deviations from this expected value can be quantified.

Given a LOESS estimate of drug-first fraction for MI across various drug frequencies, the observed error is the difference between the LOESS estimate and the true observed value. The squares of these quantities are observed squared errors. The observed local variance is subsequently computed by running a separate LOESS fit on the observed squared errors with respect to the drug frequencies. The square roots of the local variances are the local standard deviations. Finally, the local z-score is defined as the quotients of the local errors divided by the local standard deviations.

In the previous step, the disease—MI—is fixed and the drug-first fraction is estimated with respect to drug frequencies. Next, the drug—Vioxx—is fixed and, analogously, a LOESS regression of the drug-first fraction measured against disease frequencies across all diseases is fit to generate a second estimate for the drug-first fraction for Vioxx-MI. This is illustrated in FIG. 11. As shown, LOESS provides a baseline (e.g., Vioxx versus all diseases): for each disease Z. The x-axis is the total count of patients whose record ever mentions disease Z. The y-axis is the drug-first fraction for Vioxx-Z. As observed, common disease concepts, have lower baseline expected value for drug-first fraction. The local one standard deviation lines are also shown.

There are now two distinct estimates, two distinct local variances, and two distinct local z-scores for the drug-first fraction of the pair Vioxx-MI. The two estimates, if compared to the actual observed drug-first fraction of Vioxx-MI, serve as baseline expected values. The two local z-scores serve as measures by which the frequency of observed Vioxx-MI deviates from expectations. The two LOESS local z-scores, alongside the observed drug-first fraction, capture the temporal ordering information implicit in the Vioxx-MI pairing.

In addition to the drug-first fraction, analogous estimates and analogous z-scores are also produced for the co-mention counts. Continuing the Vioxx-MI example, two estimates and two local z-scores of the Vioxx-MI co-occurrence frequency would be produced. One estimate is based on drug-MI co-occurrences across all drugs. The other estimate is based on Vioxx-disease co-occurrences across all diseases.

In summary, six quantities are introduced: two LOESS estimates for drug-first fraction, the actual drug-first fraction, two estimates for the co-occurrence count, and the actual observed co-occurrence count.

The LOESS estimates are designed to alleviate drug-specific, disease-specific, and frequency-based sources of confounding. From purely a statistical point of view, for a fixed disease, and across many drugs, the more frequent the drug, the higher the drug-first fraction should be expected. Similarly, for a fixed drug, across many diseases, the more frequent the disease, the lower the drug-first fraction should be expected. For co-mentions, both increasing the drug frequency and increasing the disease frequency should lead to a higher co-mention estimate.

LOESS estimates account for these sources of confounding by anticipating their effects. Functions that only increase or only decrease are known as monotonic functions; in the aforementioned sources of confounding, the regression fits should be monotonic. When estimating monotonic functions, simply enforcing the monotone property by sorting the y-values improves the estimate and does no harm. This technique is applied to the LOESS calculations.

For each drug-disease pair, six per-pair quantities have been described as features. Three are based on the notion of the drug-first fraction—the fraction of pairs in which the mention of the drug precedes the mention of the disease; and the other three are based on the co-occurrence. In an embodiment, the logarithm of the co-occurrences is taken to place these quantities into logarithmic space. Table 1 lists all features used for classification.

TABLE 1
Features used in classification.

| Linear Space Features | Logarithmic Space Features |
|---|---|
| Drug frequency | Drug frequency |
| Disease frequency | Disease frequency |
| Observed drug-first fraction | Observed co-mention count |
| Drug-first fraction z-score | Co-mention count z-score |
| (fixed drug) | (fixed drug) |
| Drug-first fraction z-score | Co-mention count z-score |
| (fixed disease) | (fixed disease) |

The training set in this embodiments comprises 1,550 samples: 980 indications and 570 adverse events. Each feature is normalized to have mean zero and variance one for these 1,550 drug-disease pairs. A support vector machine (SVM) is applied on the ten features to produce a classifier that can classify any given drug-disease pair into drug-indication and drug-AE classes if given the ten feature quantities for that pair.

In an embodiment, SVMs were used for the primary reason that SVMs make fewer assumptions about the classification boundary than traditional methods like logistic regression. Another consideration was that the classifier was desired to at least consider a strict superset of decision boundaries available to traditional ROR disproportionality studies. SVMs models can encompass linear relations with respect to its features. The log reporting odds ratio is encoded by a linear combination of three log-space features: drug frequency, disease frequency, and observed co-mention count. In other embodiments, however, SVMs need not be used as would be obvious to those of ordinary skill in the art.

To evaluate results obtained from an embodiment of the present invention, 100-fold cross-validation was applied. Independent validation was also applied using a set of known drug-indications and drug-adverse events, which were not used in training The external source of indications was a list of indications from the Medi-Span Drug Indication Database™, which were not used in training. The external list of adverse events was taken from the public version of Adverse Event Reporting System (AERS). To filter out spurious relations, attention was limited to reports that contain either only one suspect drug or only one adverse event. Attention was further limited to pairs that have a raw frequency of at least 500 to further filter spurious relations.

The adverse events in the training set comprise 570 known adverse events taken from Medi-Span. Only adverse events marked by Medi-Span were used in the most severe category and most frequent category. The 980 indications consist of drug-disease pairs from the NDFRT ontology connected by “may_treat” relations. For both the adverse events and the indications, the only criterion of admittance into the training set was based on having at least 1,000 co-occurrences within STRIDE. This filter criterion applies to the independent validation set as well. These details are provided as an example and are not intended to limit the present invention in any way. Indeed, those of ordinary skill in the art would understand that many variations to the embodiments of the present invention are possible.

FIG. 13 shows that good performance is achieved using an embodiment of the present invention in distinguishing adverse events from indications. The area under the receiver operating curve (AUC) was 0.85 in cross-validation and 0.846 in independent validation. To independently validate, a database of 79,966 pairs of known indications from Medi-Span (43,159 from FDA labels, 16,639 commonly accepted off-label uses, and 20,178 off-label uses having limited evidence) was used. Subject to the 1,000 co-occurrences threshold in STRIDE, the analysis workflow retains 28,015 pairs.

Analogously, from 851 AERS adverse event pairs that occurred at least 500 times in AERS, the analysis workflow according to an embodiment of the present invention retained 385 pairs. The classifier trained on the original training set achieved an AUC of 0.846 in this independent validation. The classifier uses only ten features and retains performance on independent validation; thus, the method according to an embodiment of the present invention does not suffer from significant over-fitting.

Given the amount of data available in AERS, researchers are developing methods for detecting new or latent multi-drug adverse events, for detecting multi-item adverse events, and for discovering drug groups that share a common set of adverse events. Biclustering and association rule mining are able to capture many-to-many relations between drugs and adverse events. Increasingly there are efforts to use other data sources, such as EHRs, for the purpose of detecting potential new AEs in order to counterbalance the biases inherent in AERS and to discover multi-drug AEs. Researchers have also attempted to use billing and claims data for active drug safety surveillance, applied literature mining for drug safety, and tried reasoning over published literature to discover drug-drug interactions based on properties of drug metabolism.

An embodiment of the present invention takes a complementary approach that begins with the medical record. Advantageously, medical records provide backgrounds frequencies unaffected by some of the reporting biases that afflict AERS, thus providing reliable denominator data. An embodiment uses the frequency distribution and the temporal ordering of drug-disease pairs in a large corpus to define ten features on which known drug-indication and drug-AE pairs can be identified with high accuracy. Approaching the problem in this manner allows an embodiment of the present invnetion to comprehensively track the drug and disease contexts in which the AE patterns occur and use those patterns to evaluate putative new AEs. The ability to distinguish indications from adverse events directly opens up the possibility of detecting new drug-AE pairs. Embodiment of the present invention assists in the detection of multi-drug-multi-disease associations.

Results discussed above hinge upon the efficacy of the annotation mechanism among other things. Described above, Mgrep was used in the annotator according to an embodiment of the present invention. The precision of concept recognition varies depending on the text in each resource and type of entity being recognized: from 87% for recognizing disease terms in descriptions of clinical trials to 23% for PubMed abstracts, with an average of 68% across four different sources of text. For text in clinical reports, certain results show a 93% recall for detecting drug mentions in clinical text using RXNORM. In other embodiments, manual chart review for random samples of reports can be used to validate the ability to recognize drugs and diseases in medical records.

Embodiments of the present invention distinguish drug-indication pairs from drug-AE pairs. Different or improved NLP methods may improve the results obtainable from embodiments of the present invention.

Temporal ordering of first mentions in medical records is subject to sources of confounding. Clinically, some diseases like dementia or cancer tend to afflict older populations, so their first mentions are more likely to temporally follow drugs in general. From purely a statistical perspective, common concepts are more likely to have an earlier first-mention than rare concepts. The LOESS regression estimate as discussed above accounts for the above sources of confounding.

Beyond indications and adverse events, embodiments of the present invention can be used more generally such as to recognize likely off-label drug usages.

Variations of the embodiments described above include the use of a temporal sliding window (as opposed to first mentions) for detecting off-label drug usage. This is intended to address issues where, for example, some adverse effects may surface only years after the treatment while others are acute. Adjustable windowing can refine the ability to characterize and distinguish adverse events. Clinical notes also contain rich contextual markers like section headings (e.g., family medical history) that may improve the precision of the analysis when taken into account in other embodiments of the present invention.

In an embodiment described above, drugs were treated as drug ingredients, which is at a very fine granularity. In another embodiment, aggregation can be performed and analysis conducted at the drug, drug class, and drug combination levels.

In an embodiment described above, disease terms were restricted to SNOMED-CT because SNOMED-CT is the domain of disease concepts connected by “may_treat” relations as defined in NDFRT. The described workflow relied on the “may_treat” relations to train the SVM to recognize indications. In contrast to NDFRT, AERS specifies its diseases using the Medical Dictionary for Regulatory Activities (MedDRA) ontology. To map these AERS disease terms to SNOMED-CT, the annotation workflow according to an embodiment of the present invention was applied on the AERS text itself as well as used the synonymy relations between MedDRA and SNOMED-CT found in UMLS. In the annotation of the medical records, these synonymy relations were used so as to include additional synonyms and linguistically colloquial phrases offered by MedDRA.

In an embodiment described above, MedDRA terms that were unmapped to SNOMED-CT were excluded. A single ontology was used because it makes the hierarchical aggregation easier to interpret. Aggregation is one of the most computationally expensive tasks. Because methods of the present invention were applied using SNOMED-CT, the largest of the ontologies, the same methods can be applied to reason simultaneously over many other ontologies.

Compared to SNOMED-CT, MedDRA is not as exhaustive in enumerating plural forms and synonyms. Using MedDRA would reduce the recall of the annotation workflow according to embodiments of the present invention, which rely on exact matches. For this reason, SNOMED-CT was used as the primary ontology for disease terms and included MedDRA terms that could be mapped to it. Other embodiments, need not implement SNOMED-CT in the same way.

Statistically significant co-occurrences of drug-disease mentions in the clinical notes can be used to detect drug safety signals using methods according to embodiments of the present invention. Currently, when examining pairs of drug-disease co-occurrences from textual clinical notes, a major challenge is to discern indications from adverse events (AEs) in a drug-disease pair. Using embodiments according to the present invention, it is possible to make this distinction by combining the frequency distribution of the drug, the disease, and the drug-disease pair as well as the temporal ordering of the drugs and diseases in each pair across more than one million patients.

According to certain embodiments of the present invention, by using LOESS regression models derived from one million patients' records, which does not make independence assumptions built into traditional disproportionality based methods, basic sources of confounding were accounted. Through a novel combination of using large datasets, annotation, and analytics, drug indications were discerned from adverse events with good independent validation performance.

It should be appreciated by those skilled in the art that the specific embodiments disclosed above may be readily utilized as a basis for modifying or designing other image processing algorithms or systems. It should also be appreciated by those skilled in the art that such modifications do not depart from the scope of the invention as set forth in the appended claims.

What is claimed is:

1. A computer-implemented method for de-identifying digital information records, comprising:
annotating digital information records including creating timelines of patient events for first occurrences of drug mentions and disease mentions;
creating drug-disease pairs for a plurality of patients;
filtering the drug-disease pairs according to a first criteria;
aggregating the drug-disease pairs according to a hierarchy;
performing at least one regression on the aggregated information;
training a classifier based on the results of the at least one regression; and
classifying a drug-disease pair as an adverse event.

2. A computer-implemented method for de-identifying digital information records, comprising:
receiving a list of terms of interest that may exist within digital information records, wherein the list of terms do not include terms that uniquely identify an individual;
receiving at least one digital information record corresponding to at least one individual, wherein the at least one digital information record includes information that uniquely identifies at least one individual;
identifying an occurrence within the at least one digital information record of terms from the list of terms; and
collecting the occurrence of terms as a set of terms, wherein the set of terms does not include information that uniquely identifies the at least one individual.

3. The method of claim 2, wherein the digital information record is a digital medical record.

4. The method of claim 3, wherein the list of terms of interest is a list of descriptive patient features.

5. The method of claim 4, wherein the list of descriptive patient features is based on at least one of drug, disease, or anatomy ontologies.

6. The method of claim 2, further comprising identifying a negated occurrence within the at least one digital information record of terms from the list of terms.

7. The method of claim 2, further comprising analyzing the collected set of terms.

8. The method of claim 2, further comprising collecting information associated with at least some of the terms from the list of terms.

9. The method of claim 8, wherein the collected information includes a frequency of occurrence for at least one term of interest.

10. The method of claim 8, wherein the collected information includes syntactic information for at least one term of interest.

11. A computer-readable medium including instructions that, when executed by a processing unit, causes the processing unit to de-identify digital information records, by performing the steps of:
receiving a list of terms of interest that may exist within digital information records, wherein the list of terms do not include terms that uniquely identify an individual;
receiving at least one digital information record corresponding to at least one individual, wherein the at least one digital information record includes information that uniquely identifies at least one individual;
identifying an occurrence within the at least one digital information record of terms from the list of terms; and
collecting the occurrence of terms as a set of terms, wherein the set of terms does not include information that uniquely identifies the at least one individual.

12. The computer-readable medium of claim 11, wherein the digital information record is a digital medical record.

13. The computer-readable medium of claim 12, wherein the list of terms of interest is a list of descriptive patient features.

14. The computer-readable medium of claim 13, wherein the list of descriptive patient features is based on at least one of drug, disease, or anatomy ontologies.

15. The computer-readable medium of claim 11, further comprising identifying a negated occurrence within the at least one digital information record of terms from the list of terms.

16. The computer-readable medium of claim 11, further comprising analyzing the collected set of terms.

17. The computer-readable medium of claim 11, further comprising collecting information associated with at least some of the terms from the list of terms.

18. The computer-readable medium of claim 17, wherein the collected information includes a frequency of occurrence for at least one term of interest.

19. The computer-readable medium of claim 7, wherein the collected information includes syntactic information for at least one term of interest.
